(19) United States
(12) Patent Application Publication
(10) Pub. No.: US 2025/0026442 A1
(43) Pub. Date: Jan. 23, 2025

(54) BICYCLE PROPULSION SYSTEM FOR ELECTRIC BICYCLE CONVERSION

(71) Applicant: Aram Novikov, Reno, NV (US)

(72) Inventor: Aram Novikov, Reno, NV (US)

(21) Appl. No.: 18/827,507

(22) Filed: Sep. 6, 2024

Related U.S. Application Data
(63) Continuation-in-part of application No. 16/793,588, filed on Feb. 18, 2020, now Pat. No. 11,325,677.
(60) Provisional application No. 63/537,065, filed on Sep. 7, 2023.
(60) Provisional application No. 62/806,817, filed on Feb. 17, 2019.
(60) Provisional application No. 62/806,898, filed on Feb. 17, 2019.

(51) Int. Cl. B62M 6/65; B62J 43/13; B62M 9/00

(52) U.S. Cl. CPC B62M 6/65; B62M 9/00; B62J 43/13; B62K 2204/00

(57) ABSTRACT

One variation of a bicycle propulsion system includes: hub adapter configured to install on a rear axle of a bicycle and apply torque to the rear axle through a rear disk brake of the bicycle; a first rotor element; a second rotor element cooperating with the first rotor element to form a circular outer drive surface around the rear disk brake; a set of hub adapter brackets configured to engage the hub adapter; a chassis configured to transiently couple to a frame element of the bicycle; a rotor retainer arranged on the chassis and configured to locate the first rotor element and the second rotor element relative to the chassis; a motor mounted to the chassis; and a drive assembly arranged on the chassis and configured to transfer torque output by the motor into the circular outer drive surface to rotate the rear axle via the set of hub adapter brackets.

### CROSS-REFERENCE TO RELATED APPLICATIONS

This Application claims the benefit of U.S. Provisional Application No. 63/537,065, filed on 7 Sep. 2023, which is incorporated in its entirety by this reference.

This Application is also a continuation-in-part application of U.S. patent application Ser. No. 16/793,588, filed on 18 Feb. 2020, which claims the benefit of U.S. Provisional Application No. 62/806,817, filed on 17 Feb. 2019, and U.S. Provisional Application No. 62/806,898, filed on 17 Feb. 2019, each of which is incorporated in its entirety by this reference.

### TECHNICAL FIELD

This invention relates generally to the field of electric bicycle propulsion and more specifically to a new and useful electric bicycle conversion system in the field of electric bicycle propulsion.

### BRIEF DESCRIPTION OF THE FIGURES

FIG. 1 is a schematic representation of one variation of a system;

FIG. 2 is a schematic representation of one variation of the system;

FIG. 3 is a schematic representation of one variation of the system;

FIG. 4 is a schematic representation of one variation of the system;

FIG. 5 is a schematic representation of one variation of the system;

FIG. 6 is a schematic representation of one variation of the system;

FIG. 7 is a schematic representation of one variation of the system;

FIG. 8 is a schematic representation of one variation of the system;

FIG. 9 is a schematic representation of one variation of the system;

FIG. 10 is a schematic representation of one variation of the system;

FIG. 11 is a schematic representation of one variation of the system;

FIG. 12A is a schematic representation of one variation of the system;

FIG. 12B is a schematic representation of one variation of the system;

FIG. 13 is a schematic representation of one variation of the system;

FIG. 14 is a schematic representation of one variation of the system;

FIG. 15 is a schematic representation of one variation of the system;

FIG. 16 is a schematic representation of one variation of the system;

FIG. 17 is a schematic representation of one variation of the system;

FIG. 18 is a schematic representation of one variation of the system;

FIG. 19 is a schematic representation of one variation of the system;

FIG. 20 is a schematic representation of one variation of the system;

FIG. 21 is a schematic representation of one variation of the system; and

FIG. 22 is a schematic representation of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Bicycle Propulsion System

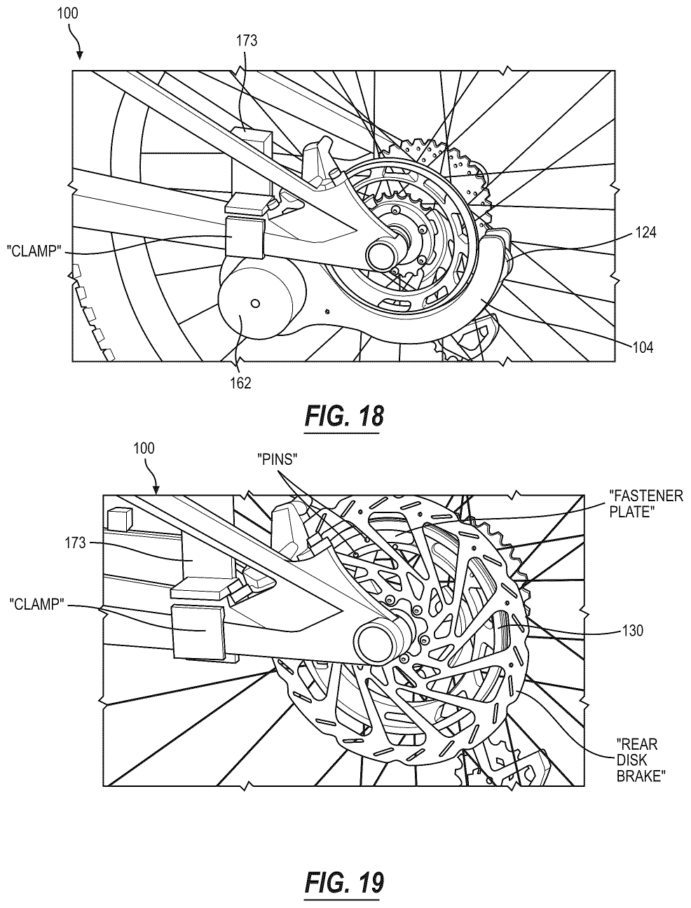

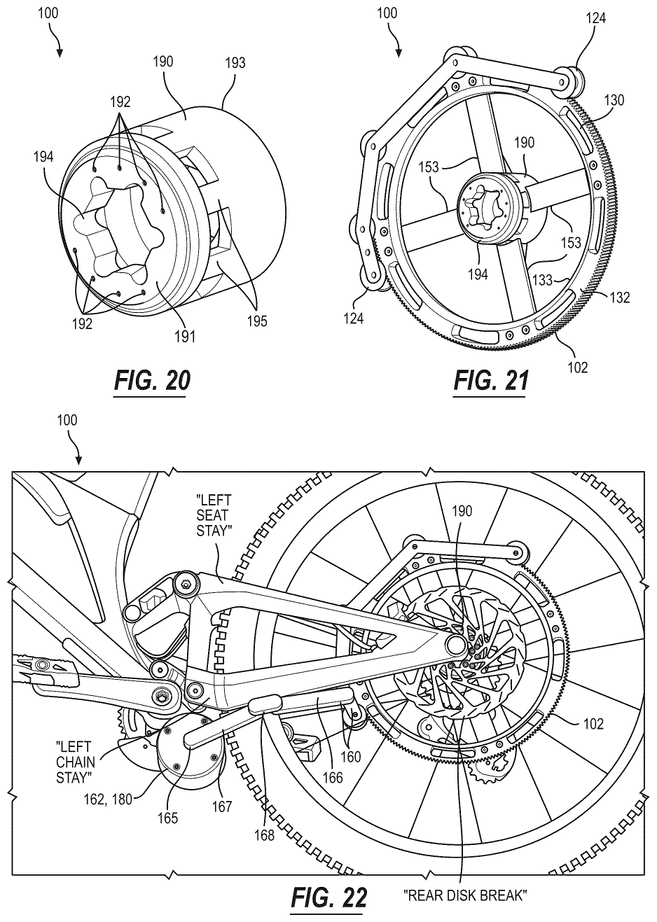

As shown in FIGS. 18, 20, 21, and 22, a bicycle propulsion system 100 includes: a hub adapter 190; a concentric rotor assembly; and a chassis assembly 104. The hub adapter 190 defines a set of external engagement features 195 and is configured to intransiently install on a rear axle of a bicycle and apply torque to the rear axle through a rear disk brake of the bicycle.

The concentric rotor assembly is operable in an open configuration and a closed configuration and includes: a first rotor element 134; a first rotor element 136 cooperating with the first rotor element 134 to form a circular outer drive surface 132 around the rear disk brake in the closed configuration; a first hub adapter bracket 157 extending inwardly from the first rotor element 134 and defining a first set of retention features 153 configured to engage and retain the set of external engagement features 195 of the hub adapter 190 in the closed configuration; and a second hub adapter bracket 158 extending inwardly from the first rotor element 136 and defining a second set of retention features 153 configured to engage and retain the set of external engagement features 195 of the hub adapter 190 in the closed configuration.

The chassis assembly 104 is configured to transiently couple to a frame element of the bicycle and includes: a retention subassembly configured to locate the concentric rotor assembly, in the closed configuration, relative to the chassis assembly 104; a motor; and a drive subassembly configured to transfer torque output by the motor into the circular outer drive surface 132, formed by the first rotor element 134 and the second rotor element 136 in the closed configuration, to rotate the rear axle via the first hub adapter bracket 157 and the second hub adapter bracket 158.

One variation of the bicycle propulsion system 100 includes: a hub adapter 190; an annular rotor assembly 102; a rotor retainer; and a power transmission assembly 160. The hub adapter 190 is configured to intransiently install on a rear axle of a bicycle and apply torque to the rear axle through a rear disk brake of the bicycle. The annular rotor assembly 102 is operable in an open configuration and a closed configuration and includes: a first rotor element 134; a first rotor element 136 cooperating with the first rotor element 134 to form a circular outer drive surface 132 around the rear axle in the closed configuration, the circular outer drive surface 132 defining a timing belt; a first hub adapter bracket 157 inset from the first rotor element 134, coupled to the first rotor element 134, and configured to engage the hub adapter 190 in the closed configuration; and a second hub adapter bracket 158 inset from the first rotor element 136, coupled to the first rotor element 136, and configured to engage the hub adapter 190 in the closed configuration.

In this variation, the rotor retainer is configured to transiently couple to a frame element of the bicycle and locate the annular rotor assembly 102, in the closed configuration, relative to the frame element. The power transmission assembly 160: includes a motor proximal the frame element of the bicycle; includes an articulated arm mounted to the motor and configured to mesh with the timing belt; and is configured to transfer torque output by the motor to the timing belt to rotate the rear axle via the first hub adapter bracket 157 and the second hub adapter bracket 158 in the closed configuration.

One variation of the bicycle propulsion system 100 includes: a hub adapter 190; a first rotor element 134; a first rotor element 136; a first hub adapter bracket 157; a second hub adapter bracket 158; a chassis; a rotor retainer; a motor; and a drive assembly. The hub adapter 190 is configured to intransiently install on a front axle of a bicycle and apply torque to the front axle. The first rotor element 136 cooperates with the first rotor element 134 to form a circular outer drive surface 132 around a front disk brake of the bicycle in a closed configuration and decouple from the front disk brake in an open configuration. The chassis is configured to transiently couple to a frame element of the bicycle. The rotor retainer is arranged on the chassis and configured to locate the first rotor element 134 and the first rotor element 136, in the closed configuration, relative to the chassis. The motor is mounted to the chassis. The drive assembly is arranged on the chassis and configured to transfer torque output by the motor into the circular outer drive surface 132, formed by the first rotor element 134 and the first rotor element 136 in the closed configuration, to rotate the front axle via the first hub adapter bracket 157 and the second hub adapter bracket 158.

### 1.1 Variation: Bicycle Propulsion System—Sprocket Configuration

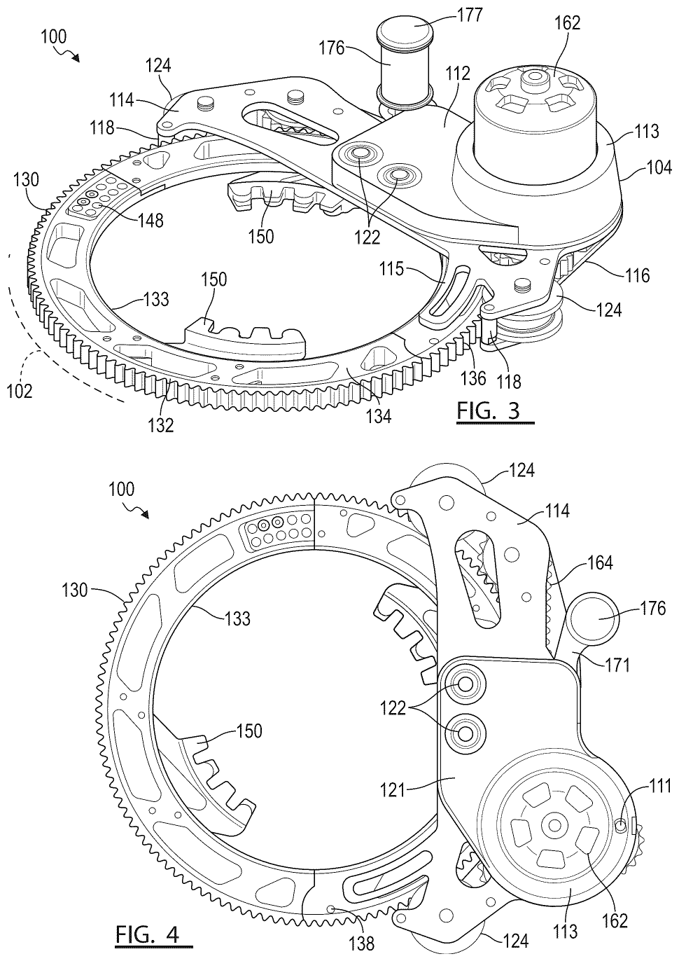

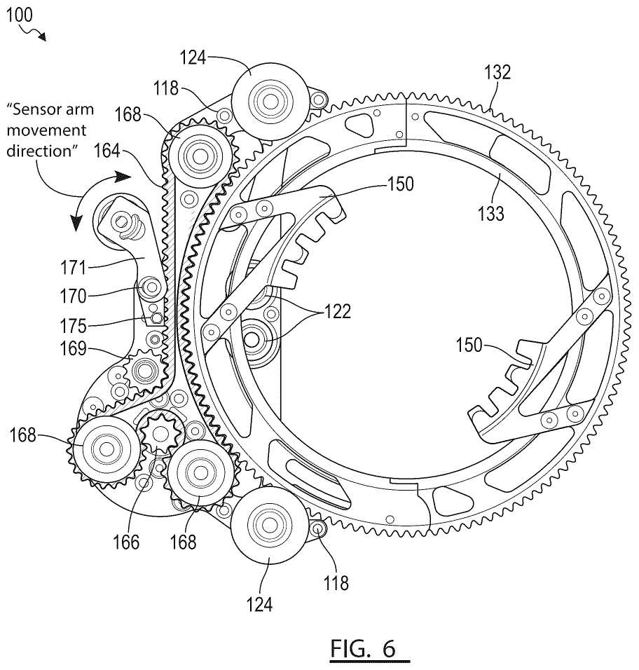

As shown in FIGS. 3 and 6, one variation of the bicycle propulsion system 100 includes: a concentric rotor assembly 102; and a chassis assembly 104. The concentric rotor assembly 102: comprises a first rotor element 134 attached to a first sprocket bracket 151 configured to engage with a first bicycle sprocket; comprises a first rotor element 136 attached to a second sprocket bracket 152 configured to engage the first bicycle sprocket; and is configured to define a circular outer drive surface 132, to define a circular inner retention surface 133, and to transiently engage around the first bicycle sprocket in an engaged configuration of the concentric rotor assembly 102 via the first sprocket bracket 151 and the second sprocket bracket 152. The chassis assembly 104: is configured to transiently secure to a bicycle frame element; includes a retention subassembly configured to translationally constrain the concentric rotor assembly 102 relative to the chassis assembly 104 while the concentric rotor assembly 102 is engaged around the first bicycle sprocket and the chassis assembly 104 is secured to the bicycle frame element; includes a drive subassembly configured to engage the concentric rotor assembly 102 via the circular outer drive surface 132; and comprises a motor 162 configured to rotate the concentric rotor assembly 102 about a center axis of the circular outer drive surface 132 via the drive subassembly, the motor 162 causing rotation of the first bicycle sprocket while the concentric rotor assembly 102 is engaged around the first bicycle sprocket.

One variation of the bicycle propulsion system 100, shown in FIGS. 3, 6, and 7, includes: a concentric rotor assembly 102 and a chassis assembly 104. In this variation, the concentric rotor assembly 102 is configured to rigidly and transiently engage around a sprocket of a bicycle and includes a set of sprocket brackets 150 arranged about the concentric rotor assembly 102, the set of sprocket brackets 150 configured to engage with teeth of the sprocket of the bicycle. In this variation, the chassis assembly 104: is configured to transiently secure to a frame element of the bicycle; comprises a retention subassembly configured to translationally constrain the concentric rotor assembly 102 relative to the chassis assembly 104; includes a drive subassembly configured to engage the concentric rotor assembly 102; includes a motor 162 configured to rotate the concentric rotor assembly 102 about a center axis of the concentric rotor assembly 102 via the drive subassembly; includes a sensor arm 171 configured to engage with a chain of the bicycle via a chain roller 176 biased against the chain of the bicycle; and includes an electronics subsystem 180. In this variation, this electronics subsystem 180 is configured to: detect deflection of the sensor arm 171 caused by tension in the chain of the bicycle; and activate the motor 162 to rotate the concentric rotor 130 based on the deflection of the sensor arm 171.

One variation of the bicycle propulsion system 100, shown in FIG. 3, includes a concentric rotor assembly 102 and a chassis assembly 104. In this variation, the concentric rotor assembly 102: defines a circular outer drive surface 132; defines an inner retention surface 133; comprises a set of sprocket brackets 150 arranged about the inner retention surface 133 of the concentric rotor assembly 102 and configured to engage with teeth of a bicycle sprocket; and is configured to transiently engage around the bicycle sprocket, wherein a center axis of the circular outer drive surface 132 is concentric with a rotational axis of the bicycle sprocket. In this variation, the chassis assembly 104: is configured to transiently secure to a stay of the bicycle; includes a retention subassembly configured to translationally constrain the concentric rotor assembly 102 relative to the chassis assembly 104; and includes a drive subassembly configured to engage the circular outer drive surface 132 of the concentric rotor assembly 102; and includes a motor 162 configured to rotate the concentric rotor assembly 102 about a center axis of the circular outer drive surface 132 via the drive subassembly.

### 2. Applications

Generally, a bicycle propulsion system 100 includes: an hub adapter 190 configured to intransiently (e.g., semi-permanently) install on a rear axle of a bicycle (e.g., a rear wheel hub of the bicycle) and apply torque to the rear axle through a rear disk brake of the bicycle; a rotor configured to transiently couple to the hub adapter 190; a chassis assembly 104 configured to transiently couple to a frame element of the bicycle (e.g., a chain stay of the bicycle, a seat stay of the bicycle); and a motor arranged proximal the frame element of the bicycle and/or within the chassis assembly 104 and configured to drive the rotor, thereby generating additional torque about the rear axle of the bicycle, through the rear disk brake, and assisting a rider operating the bicycle.

For example, a cyclist may install the bicycle propulsion system 100 on a left side (or “off-side”) of her bicycle (i.e., opposite the chain and sprockets) in order to convert her standard (e.g., analog, acoustic or push) mountain bicycle into an electric bicycle to traverse more difficult terrain or grade of a trail. The cyclist can then easily remove the bicycle propulsion system 100: to use the bicycle to traverse less difficult terrain; to comply with legal restrictions on electric bicycles in a particular area; to prevent theft of the bicycle propulsion system 100 while parking her bicycle; or for any other reason. Likewise, the cyclist can easily reinstall the bicycle propulsion system 100 whenever she desires additional throttle and/or pedal assistance.

### 2.1 System Elements

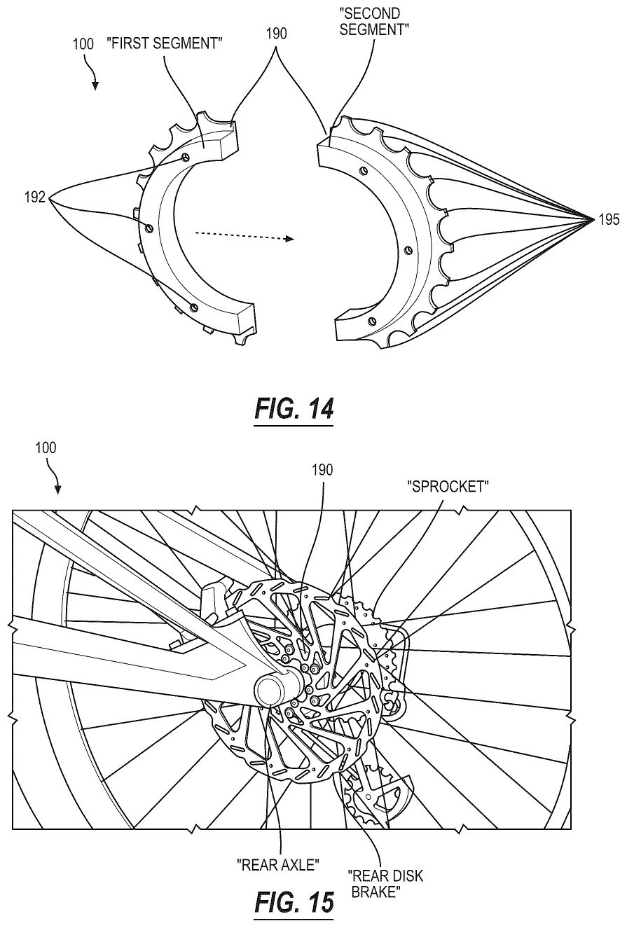

More specifically, as shown in FIGS. 14, 15, 20, and 21, the bicycle propulsion system 100 includes: an hub adapter 190 including a set of segments configured to intransiently install and encircle the rear axle (e.g., rear wheel hub); a concentric rotor assembly 102 (hereinafter “an annular rotor assembly 102”) including a set of hub adapter 190 brackets configured to transiently mount to the hub adapter 190 and/or the rear disk brake of a bicycle in a closed configuration and configured to decouple from the hub adapter 190 in an open configuration; and a chassis assembly 104 that secures to the annular rotor assembly 102 in the closed configuration, transiently couples to a chain stay or seat stay of the bicycle, and includes a motor 162 and drive subassembly that transmits torque to the annular rotor assembly 102. The annular rotor assembly 102 is configured to open (or “split”) to enable installation over and removal from the rear disk brake of the bicycle without necessitating removal of the rear wheel from rear dropouts of the bicycle frame. The annular rotor assembly 102 is also configured to close and latch around the rear disk brake in the closed configuration in which the outer surface of the annular rotor assembly 102 forms a continuous, circular outer drive surface 132, and in which hub adapter 190 brackets, extending toward the radial center of the annular rotor assembly 102, engage and retain external engagement features 195 of the hub adapter 190 in order to transmit torque between the circular outer drive surface 132 and the rear axle.

The chassis assembly 104 includes: a set of rollers configured to engage and retain the annular rotor assembly 102 when the annular rotor assembly 102 is installed around the rear disk brake; and a toothed drive belt 164 that runs between these rollers and the circular outer drive surface 132 of the annular rotor assembly 102 and transmits torque from an electric motor-remote from the chassis assembly 104 or arranged within the chassis assembly 104-into the annular rotor assembly 102, which then transmits torque into the rear axle via the hub adapter 190 brackets. Furthermore, the chassis assembly 104 includes a boss or rest configured to engage a seat stay or chain stay near rear drops of the bicycle frame and thus prevent rotation of the chassis assembly 104 about a pitch axis of the bicycle when the motor is actuated; and a strap or other coupler configured to wrap around the seat stay or chain stay of the bicycle and thus constrain rotation of the chassis assembly 104 about a yaw axis of the bicycle while the annular rotor assembly 102 and the rollers cooperate to constrain translation of the chassis assembly 104 and rotation of the chassis assembly 104 about a roll axis of the bicycle.

### 2.2 Off-Side Installation

During installation, a user (e.g., a rider) may install the hub adapter 190 onto a rear wheel hub of a bicycle-opposite the rear chain sprocket(s) or cassette-by mounting the set of (e.g., two) segments around the rear wheel hub and to a rear disk brake via a set of fasteners threaded through cut outs of the rear disk brake and into bores of each segment. The user may then: install the chassis assembly 104 on the bicycle frame by wrapping the strap around a left seat stay and/or left chain stay of the bicycle near a rear dropout of the bicycle without additional tools; and install an articulated arm, coupled to the chassis assembly 104, by wrapping an additional strap, clamp, or other fastener to the left chain stay to locate the motor against a bottom face of the chain stay and/or the bicycle frame (e.g., near a bottle holder mounted on the bicycle frame). The user may install the annular rotor assembly 102 around the rear disk brake of the bicycle by pivoting a first rotor element 134, coupled to a first hub adapter bracket 157, on a first rotor element 136, coupled to the second hub adapter bracket 158, to transition the annular rotor assembly 102 from the closed configuration to an open configuration.

Accordingly, the user may: locate the first hub adapter bracket 157, coupled to the first rotor element 134, around the rear disk brake and proximal the external engagement features 195 of the hub adapter 190; feed the first rotor element 134 into the chassis assembly 104 along the retaining rollers; close the first rotor element 136 against an opposite side of the hub adapter 190 to locate the second hub adapter bracket 158 proximal the external engagement features 195 of the hub adapter 190; latch the first rotor element 136 to the first rotor element 134 to form a contiguous annulus, concentric with the rear disk brake; and, by extension, couple the first hub adapter bracket 157 and the second hub adapter bracket 158 to the external engagement features 195 of the hub adapter 190. The user may then: place a battery assembly 106 in a bottle holder mounted on the bicycle frame; and route a power cable from the battery assembly 106 to the motor and/or the chassis assembly 104 to complete assembly of the bicycle propulsion system 100 on the bicycle, such as in under one minute. Later, these elements of the bicycle propulsion system 100 can be similarly removed from the bicycle over a similar duration of time in order to return the bicycle to an unassisted configuration.

Therefore, the bicycle propulsion system 100 includes an hub adapter 190, a chassis assembly 104, and an annular rotor assembly 102 that cooperate: to enable rapid installation onto a bicycle when a user desires torque assistance (e.g., in preparation for a trail ride); and to enable rapid removal from this bicycle, such as when the user parks the bicycle in a public space or when the user no longer desires throttle and/or pedal assistance (e.g., in preparation for a bike ride with friends or when cycling along a flat segment of a trail), all without additional tools and without necessitating removal of a wheel or other native components from the bicycle. Thus, the bicycle propulsion system 100 can enable convenient and temporary conversion of a purely manual mountain bicycle to an electric bicycle with throttle and/or pedal assistance and vice versa, thereby enabling a cyclist to rapidly and seamlessly transition a single bicycle between a manual configuration and an electric bicycle configuration.

### 3. Annular Rotor Assembly

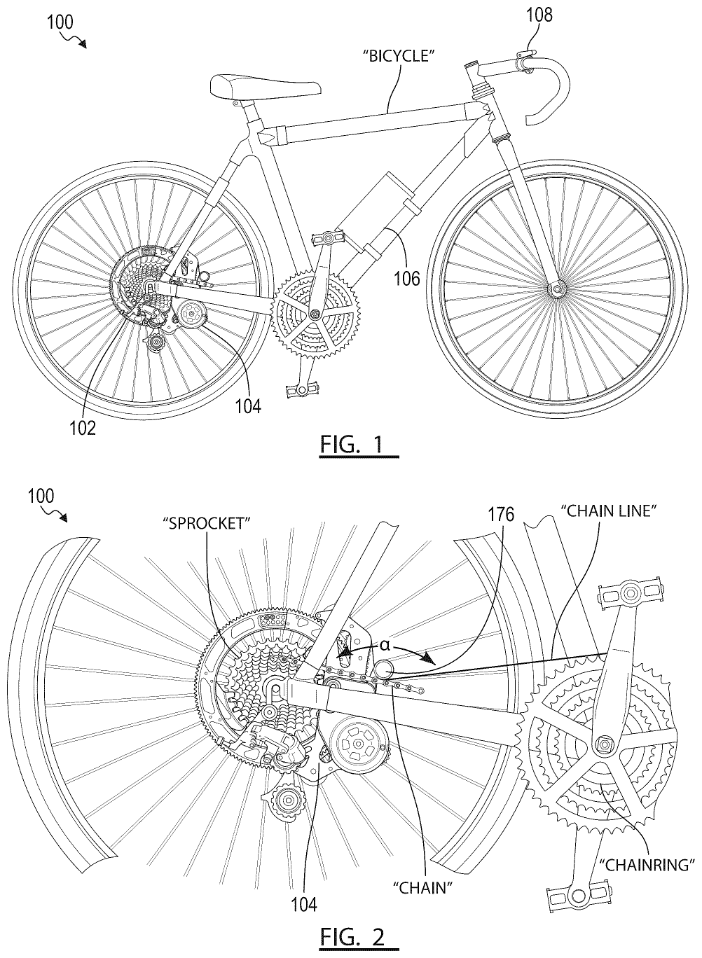

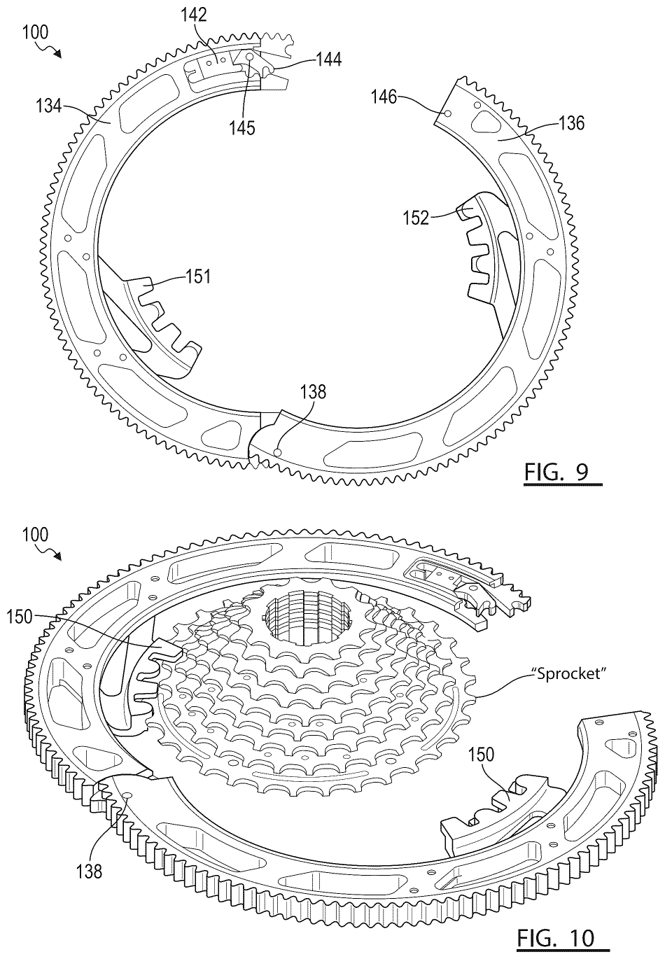

Generally, the bicycle propulsion system 100 includes a annular rotor assembly 102 that is clamped around or that otherwise engages a sprocket of a bicycle cogset, as shown in FIGS. 1, 8, 9, and 10. More specifically, the bicycle propulsion system 100 includes a annular rotor assembly 102 configured to transiently engage around a sprocket of a bicycle and including a set of sprocket brackets 150 arranged about the annular rotor assembly 102, the set of sprocket brackets 150 configured to engage with teeth of a sprocket of the bicycle. Additionally, the bicycle propulsion system 100 includes a annular rotor assembly 102 that: includes a circular outer drive surface 132 and a circular inner retention surface 133, thereby defining surfaces for the retention subassembly to translationally constrain the annular rotor assembly 102 relative to the chassis assembly 104 and for the drive subassembly to transfer power from the motor 162 to the annular rotor assembly 102. Furthermore, as shown in FIG. 9, the bicycle propulsion system 100 can include a annular rotor assembly 102 that further includes: a first rotor element 134 attached to a first sprocket bracket 151 and a first rotor element 136 attached to a second sprocket bracket 152, where the concentric motor 162 assembly defines the circular outer drive surface 132 and the circular inner retention surface 133 during engagement of the first rotor element 134 and the first rotor element 136 in an engaged configuration. Thus, the bicycle propulsion system 100 includes a annular rotor assembly 102 that can easily be engaged and disengaged from a sprocket of a bicycles and can efficiently and securely transfer power to the sprocket of the bicycles from the drive subassembly and motor 162 of the bicycle propulsion device.

In one implementation, as shown in FIG. 9, the bicycle propulsion system 100 includes an annular rotor assembly 102 that further includes two approximately semicircular rotor elements attached at one end by a hinge and defining male and female components of a latch 140 on the first rotor element 134 and the first rotor element 136 respectively. Upon engagement of the first rotor element 134 with the first rotor element 136, the first rotor element 134 and the first rotor element 136 define the circular outer drive surface 132 and the circular inner retention surface 133.

In another implementation, the bicycle propulsion system 100 includes a annular rotor assembly 102 that further includes two approximate semicircular rotor elements that a configured to be fully separable via two latches 140. Therefore, a user can couple each end of the two rotor elements to the corresponding end of the opposite rotor element, thereby defining the circular outer drive surface 132 and the circular inner retention surface 133.

Additional components and implementations of these components are described in further detail below.

### 3.1 Concentric Rotor

Generally, the bicycle propulsion system 100 includes a concentric rotor 130 as a primary component of the annular rotor assembly 102. More specifically, the bicycle propulsion system 100 can include a concentric rotor 130 including a centerless disk defining a circular outer drive surface 132 and defining a circular inner retention surface 133, where the circular outer drive surface 132 defines a toothed (i.e. geared) surface and the circular inner retention surface 133 is characterized by a diameter greater than the bicycle sprocket with which the concentric rotor 130 is configured to engage. Additionally, the bicycle propulsion system 100 can include a concentric rotor 130 that defines a thickness such that the concentric rotor 130 is laterally stable under load when being driven by the drive subassembly and while engaged with a bicycle sprocket, such as a thickness between 0.5 centimeters and 1.5 centimeters.

In one implementation, the concentric rotor 130 is manufactured as a single piece of rigid material before being divided into two or more separate rotor elements. For example, the concentric rotor 130 can be manufactured from a metal such as stainless steel or aluminum alloy (such as 6061 or 7075). For example, the concentric motor 162 can be milled and/or lathed from a single piece of metal. Alternatively, the concentric rotor 130 can be stamped from a single piece of metal. However, the concentric rotor 130 can be manufactured in any other way.

In another implementation shown in FIG. 8, the concentric rotor 130 can include a set of slots in order to reduce the weight of the concentric rotor 130 while leaving sufficient material to maintain structural stability of the concentric rotor 130 under load from the drive subassembly.

### 3.2 Circular Outer Drive Surface

Generally, the bicycle propulsion system 100 can include a concentric rotor 130 defining a geared circular outer drive surface 132, in order to interface with the drive subassembly. In one implementation, the bicycle propulsion system 100 can include a concentric rotor 130 configured to interface (i.e. mesh) with a toothed drive belt 164 (i.e. timing belt) housed by the chassis assembly 104. In this implementation, the circular outer drive surface 132 can define a set of curved teeth configured to interface with a rubber timing belt. Thus, by interfacing with a timing belt, the bicycle propulsion system 100 can reliably transfer power from the motor 162 to the concentric rotor 130 without lubrication or frequency maintenance.

In one implementation, the bicycle propulsion system 100, via the retention subassembly, holds the annular rotor assembly 102 relative to the chassis assembly 104 with a pair of retaining rollers that ride along the circular outer drive surface 132. However, in order to prevent damage to the retaining rollers due to impact with the toothed circular outer drive surface 132, the bicycle propulsion system 100 can include a chamfered edge at the base of the teeth of the circular outer drive surface 132 configured to engage the retaining rollers of the retention subassembly.

### 3.3 Inner Retention Surface

Generally, the bicycle propulsion system 100 can include a concentric rotor 130 defining an inner retention surface 133 at along its interior circular edge in order for the retention subassembly of the chassis assembly 104 to translationally constrain the concentric rotor 130 while feeding the concentric rotor 130 through the chassis assembly 104 such that the concentric rotor 130 rotates about its center axis. More specifically, the bicycle propulsion system 100 can include a concentric rotor 130 that defines a smooth inner retention surface 133 configured to engage with inner retaining rotors. Additionally, to prevent procession of the concentric rotor 130 during rotation, the concentric rotor 130 can define a circular inner retention surface 133 that is concentric with the circular outer drive surface 132 and the rotational axis of the sprocket with which the annular rotor assembly 102 is configured to engage. In one implementation, the concentric rotor 130 defines an inner retention surface 133 that includes a chamfer corresponding to an interior chamfer of the inner retaining rollers 122 in the retention subassembly.

### 3.4 Rotor Elements

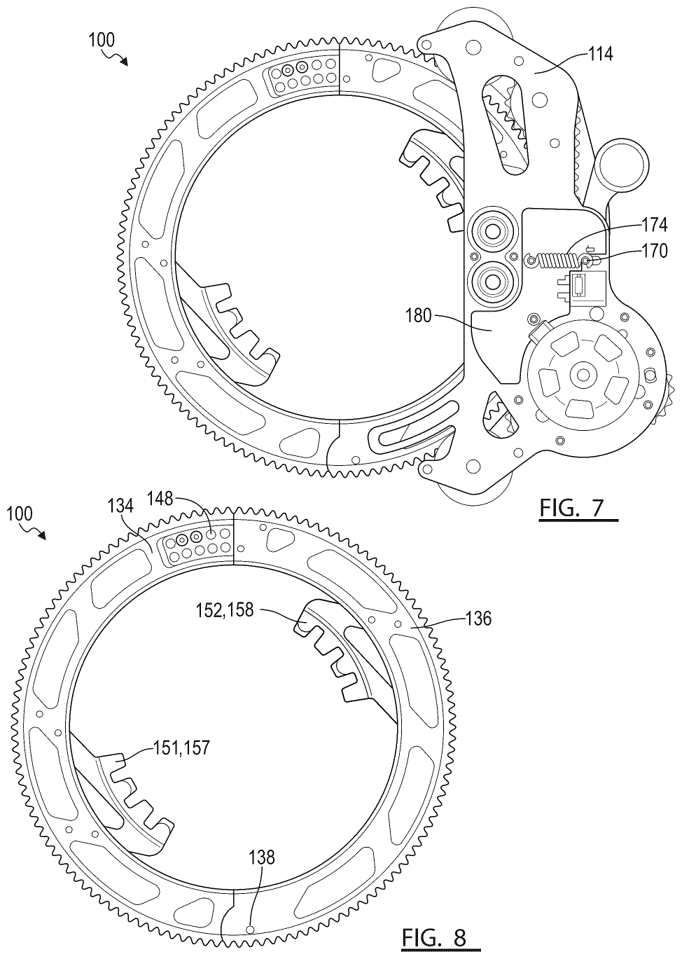

Generally, as shown in FIGS. 6 and 7, the bicycle propulsion assembly includes a concentric rotor 130 that further includes two (partially or completely) separable rotor elements, each rotor element defining an arc of the complete concentric rotor 130, in order to enable a cyclist to open the concentric rotor 130 around the sprocket of the bicycle and clamp the concentric rotor 130 around this sprocket. More specifically, the annular rotor assembly 102 includes: a first rotor element 134 attached to a first sprocket bracket 151 configured to engage with a bicycle sprocket; and a first rotor element 136 attached to a second sprocket bracket 152 configured to engage the bicycle sprocket. In one implementation, the annular rotor assembly 102 includes: a first rotor element 134 attached to a first sprocket bracket 151 in a set of sprocket brackets 150; and a first rotor element 136 attached to a second sprocket bracket 152 in the set of sprocket brackets 150 and configured to transiently couple to the first rotor element 134 to define the circular outer drive surface 132 and the inner retention surface 133. Thus, upon engagement of the first rotor element 134 with the first rotor element 136 (e.g., via latches and/or a hinge), the first rotor element 134 and the first rotor element 136 combine to define the circular outer drive surface 132 and the circular inner retention surface 133.

In one implementation, the bicycle propulsion system 100 can include a concentric rotor 130 manufactured from a single piece of material prior to being cut into a first rotor element 134 and a first rotor element 136, thereby ensuring a precise fit between the first rotor element 134 and the first rotor element 136.

In another implementation, the bicycle propulsion system 100 can include a first rotor element 134 and a first rotor element 136 that are approximately equal in size to ensure approximately equal load is applied to each side of the sprocket of the bicycle via the first sprocket bracket 151 and second sprocket bracket 152 during rotation of the annular rotor assembly 102.

In yet another implementation, the bicycle propulsion system 100 can include additional rotor elements each attached to corresponding sprocket brackets 150 in order to more fully circumscribe the sprocket of the bicycle with sprocket brackets 150. In this implementation, the set of rotor elements can include multiple latches and/or hinges to enable a user to engage the concentric rotor 130 around the sprocket of the bicycle.

### 3.4.1 Rotor Hinge and Latch

Generally, as shown in FIG. 9, the bicycle propulsion system 100 can include a set of rotor elements coupled by a rotor hinge 138 at one side of each rotor element and transiently connected, in an engaged configuration, by a latch 140. More specifically, the bicycle propulsion system 100 can include a annular rotor assembly 102 that further includes: a hinge connecting a first rotor element 134 to a first rotor element 136, the hinge defining a rotational axis parallel to the center axis of the circular outer drive surface 132; a latch 140 inset into the first rotor element 134; and a locking pin within a lot of the first rotor element 136 configured to engage the latch 140 and prevent separation of the first rotor element 134 from the first rotor element 136 in the engaged configuration of the annular rotor assembly 102. Thus, a user may install and remove the annular rotor assembly 102 around a sprocket of a bicycle without tools and within a short period of time and, while in the engaged configuration, the annular rotor assembly 102 remains rigidly engaged around the bicycle sprocket sufficient to transfer torque from the drive subassembly to the sprocket of the bicycle.

The annular rotor assembly 102 can include a latch 140 inset into a first end of the first rotor element 134 and a latching pin 146 traversing a slot in a second end of the first rotor element 136. Thus, when a user brings the first end of the first rotor element 134 and the second end of the first rotor element 136 together and slots the latch 140 of the first rotor element 134 into the slot in the first rotor element 136, the latch 140 latches around the latching pin 146, thereby preventing disengagement of the first rotor element 134 from the first rotor element 136. Additionally, the annular rotor assembly 102 can include a latch 140 configured to release a latching pin 146 upon translation of a sliding member 148 mechanically coupled to the latch 140 and configured to enclose the latch 140 inset in the rotor element.

In one implementation, the annular rotor assembly 102 can include a latch 140 that further includes a spring-loaded linear cam 142 configured to engage with a hooked follower 144, as shown in FIG. 9. FIG. 9 shows the latch 140 in the locked position despite showing the first rotor element 134 and the first rotor element 136 as separated from each other for clarity. Upon engagement of the rotor elements, the hooked follower 144 catches the latching pin 146 on the opposite rotor element and rotates about a follower pin 145 until the linear cam 142 can translate into a slot left by the rotation of the hooked follower 144, thereby preventing back-rotation of the hooked follower 144 and, as a result, prevents disengagement of the latching pin 146 from the hooked follower 144. The latch 140 can also include sliding member 148 (not shown for clarity in FIG. 9) that is mechanically coupled to the linear cam 142 to enable the hooked follower 144 to back rotate such that, upon application of a force separating the first rotor element 134 from the second motor 162, the latching pin 146 can be removed from the hook of the hooked follower 144 as the hooked follower 144 back-rotates.

In another implementation, the annular rotor assembly 102 is configured to cooperate within the chassis assembly 104 in order to hide the latch 140 within the chassis assembly 104, thereby preventing access to the latch 140 and effectively locking the annular rotor assembly 102 around the sprocket of the bicycle for the purpose of theft prevention. More specifically, in this implementation, the chassis assembly 104 can include a solenoid, or another electromechanical latch within the chassis assembly 104, configured to engage with a corresponding slot, an indentation, or the circular outer drive surface 132 of the concentric rotor 130 such that, while the solenoid or latch is engaged, the concentric rotor is locked in place and the latch 140 is concealed by the chassis assembly 104 (i.e., the outboard frame 114). Additionally, the latch or solenoid can be actuated by a physical key or via wireless communication with an application executing a mobile computation device of the cyclist in order to engage and remove the latch or solenoid from the slot of the concentric rotor 130, thereby enabling the concentric rotor 130 to freely rotate again. Furthermore, the bicycle propulsion system 100 can: store a predefined position of the concentric rotor for which the latch 140 (and sliding member 148) is blocked against the interior surface of the outboard frame 114; and, in response to receiving a command to lock bicycle propulsion system 100 to the bicycle, the bicycle propulsion system 100 can actuate the motor 162 to move the annular rotor assembly 102 into the predefined position and engage an electromechanical pin preventing rotation of the concentric rotor 102. Therefore, the bicycle propulsion system 100 can be locked to the frame of the bicycle remotely without physical intervention by a user.

In yet another implementation, the bicycle propulsion system 100 can include other locking mechanisms such as integrated U-locks, cable locks, or folding locks configured to secure the annular rotor assembly 102 and/or the chassis assembly 104 to the frame or wheel of the bicycle. Additionally, the bicycle propulsion system 100 can include a GPS chip and an inertial measurement unit and can, while the bicycle is not in use (or upon activation of this security feature via mobile computational device of a user): detect movement of the bicycle and/or the bicycle propulsion system 100; and transmit the GPS location of the bicycle propulsion system 100 to a mobile computational device of the user. Thus, the annular rotor assembly 102 can define security features configured to prevent removal of the concentric rotor 130 from the sprocket and/or removal of the chassis assembly 104 from the bicycle.

However, the annular rotor assembly 102 can include any type of latch 140 capable of securing the first rotor element 134 to the first rotor element 136 when engaged with the sprocket of the bicycle and under load by the drive subassembly.

### 3.5 Sprocket Brackets

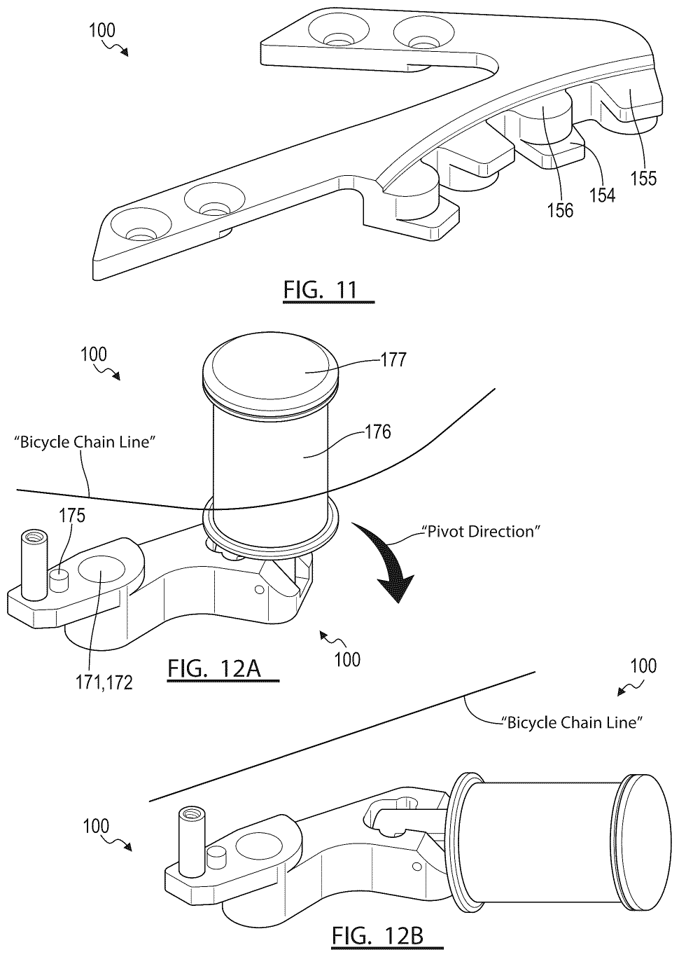

Generally, as shown in FIG. 11, the annular rotor assembly 102 can include a set of sprocket brackets 150 configured to engage with teeth of a bicycle sprocket such that torque applied to the concentric rotor 130 is transferred to the sprocket of the bicycle. More specifically, the annular rotor assembly 102 can further include a set of sprocket brackets, each sprocket bracket defining: a set of outboard retaining teeth 154 configured to engage the outer surface of the sprocket of the bicycle; a set of inboard retaining teeth 155 offset from the outboard retaining teeth 154 by greater than the thickness of the sprocket of the bicycle and configured to engage the inner surface of the sprocket of the bicycle; and a set of engagement features 156 configured to engage with pitches of the sprocket of the bicycle arranged between the set of outboard retaining teeth 154 and the set of inboard retaining teeth 155. Thus, the annular rotor assembly 102 can engage with a sprocket of a bicycle via the set of sprocket brackets 150.

The sprocket bracket can define a set of engagement features 156 that are configured to sit within the pitches (i.e. between the teeth or spurs) of the bicycle sprocket when the sprocket bracket is engaged with the sprocket of the bicycle. Therefore, the sprocket bracket can define engagement features 156 that include a series of half-cylindrical spurs mimicking one side of the rivets of a bicycle chain. In one implementation, the sprocket bracket can define engagement features 156 that include a series of half-cylindrical spurs that are characterized by a diameter less than the diameter of bicycle chain rivets configured to engage the bicycle sprocket. By including slightly smaller diameter engagement features 156 than the rivets of a bicycle chain matched to the bicycle sprocket, the sprocket bracket can more easily be installed onto the bicycle sprocket.

Additionally, the sprocket bracket can define a set of inboard retaining teeth 155 and outboard retaining teeth 154 on either side of the engagement features 156 in order to prevent lateral disengagement of the sprocket bracket from the sprocket of the bicycle (e.g., due to non-axial torque applied to the annular rotor assembly 102). Therefore, the sprocket bracket can include inboard retaining teeth 155 and outboard retaining teeth 154 characterized by a thickness less than the intra-sprocket spacing of the cogset of the bicycle. Furthermore, the sprocket bracket can include inboard retaining teeth 155 and outboard retaining teeth 154 that alternate on either side of the engagement features 156 in order facilitate engagement of the sprocket bracket with the sprocket of the bicycle by a user of the bicycle propulsion system 100, as shown in FIG. 11.

The annular rotor assembly 102 can include a set of sprocket brackets 150 with engagement features 156, inboard retaining teeth 155, and outboard retaining teeth 154, configured to engage with a sprocket of a particular size (i.e. number of teeth), with a sprocket configured for a particular chain standard (e.g., half-inch pitched chain, eighth-inch chain, three-sixteenths-inch chain, 5.3-millimeter chain, 5.5-millimeter chains, six-millimeter chain, 6.5-millimeter chain, and/or seven-millimeter chain), and with a sprocket characterized by a particular sprocket spacing. Thus, the sprocket bracket can define engagement features 156, inboard retaining teeth 155, and outboard retaining teeth 154, characterized by dimensions corresponding to the sprocket of the bicycle with which the sprocket bracket is configured to engage.

In one implementation, each sprocket bracket in the set of sprocket brackets 150 defines an engagement arc characterized by a radius equal to or greater than the pitch radius of the sprocket of the bicycle with which the sprocket bracket is configured to engage. Thus, the curvature of each sprocket bracket in the set of sprocket brackets 150 approximately matches the curvature of the bicycle sprocket with which the sprocket bracket is configured to engage.

In another implementation, the annular rotor assembly 102 can also include a set of sprocket brackets 150 that define a total arc length that is greater than 25% of the pitch circumference of the bicycle sprocket. Thus, in implementations of the annular rotor assembly 102 that include a first sprocket bracket 151 and a second sprocket bracket 152, the first sprocket bracket 151 and the second sprocket bracket 152 can be configured to engage with greater than twenty five percent of teeth of the first bicycle sprocket in the engaged configuration of the annular rotor assembly 102. For example, the annular rotor assembly 102 can include a first sprocket bracket 151 attached to a first rotor element 134 and a second sprocket bracket 152 attached to a first rotor element 136 configured to engage a sprocket defining 28 teeth. In this example, the first sprocket bracket 151 and the second sprocket bracket 152 together define an arc length and engagement features 156 configured to engage with at least seven teeth of the sprocket.

In yet another implementation, the annular rotor assembly 102 can include a set of sprocket brackets 150 that define a total arc length less than sixty percent of the pitch circumference of the bicycle sprocket. In this implementation, the set of sprocket brackets 150 can engage with less than 60% of the teeth of the bicycle sprocket. For example, the annular rotor assembly 102 can include a first sprocket bracket 151 attached to a first rotor element 134 and a second sprocket bracket 152 attached to a first rotor element 136 configured to engage a sprocket defining 28 teeth. In this example, the first sprocket bracket 151 and the second sprocket bracket 152 together define an arc length and engagement features 156 configured to engage with sixteen or fewer teeth of the sprocket.

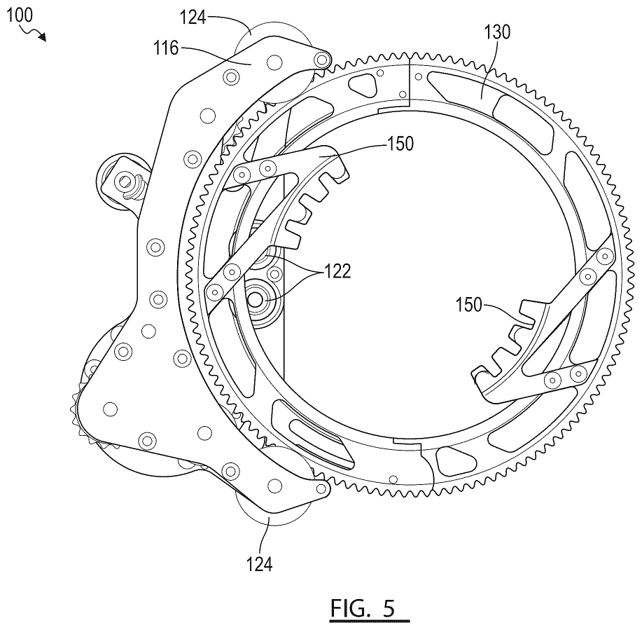

Generally, each sprocket bracket in the set of sprocket brackets 150 attaches to a corresponding rotor element via a set of sprocket struts configured to secure to a face of the concentric rotor 130, as shown in FIG. 5. In one implementation, the set of sprocket struts define a set of threaded bores 192 aligned with threaded bores 192 inset into a face of the concentric rotor 130, as shown in FIG. 11. Thus, the set of sprocket brackets 150 are replaceable and/or exchangeable by a user of the bicycle propulsion system 100.

In one implementation, the annular rotor assembly 102 includes a set of sprocket brackets 150 configured to engage with an innermost bicycle sprocket in a bicycle cogset (e.g., the largest-diameter sprocket in the cogset). More specifically, in implementations of the bicycle propulsion system 100 including a first sprocket bracket 151 and a second sprocket bracket 152: the first sprocket bracket 151 is further configured to engage with an innermost bicycle sprocket in a bicycle cogset; the second sprocket bracket 152 is further configured to engage the innermost bicycle sprocket; and the annular rotor assembly 102 is further configured to transiently engage around the innermost bicycle sprocket of the bicycle via the first sprocket bracket 151 and the second sprocket bracket 152 in the engaged configuration of the annular rotor assembly 102; the retention subassembly is further configured to translationally constrain the annular rotor assembly 102 relative to the chassis assembly 104 while the annular rotor assembly 102 is engaged around the innermost bicycle sprocket and the chassis assembly 104 is secured to the bicycle frame element; and the motor 162 is further configured to rotate the annular rotor assembly 102 about the center axis of the circular outer drive surface 132 via the drive subassembly, the motor 162 causing rotation of the innermost bicycle sprocket while the annular rotor assembly 102 is engaged around the second bicycle sprocket. Thus, the annular rotor assembly 102 can include a set of sprocket brackets 150 configured to attach to the inboard side of the concentric rotor 130 to avoid interference with other sprockets of the bicycle and defining a curve back outward such that the engagement features 156 are located between planes defined by the inboard and outboard faces of the concentric rotor 130, as shown in FIG. 10. In this implementation, the set of sprocket brackets 150 can define filleted edges to reduce force concentration in each sprocket bracket.

The set of sprocket brackets 150 can be manufactured from any hard-wearing and lightweight material capable of transferring torque from the concentric rotor 130 to the sprocket of the bicycle, such as aluminum or steel. The set of sprocket brackets 150 can be manufactured via stamping milling, additive manufacturing, or any other manufacturing techniques.

### 3.5.1 Sprocket Bracket Kit

In one implementation, the bicycle propulsion system 100 includes multiple sets of sprocket brackets 150, each set configured to engage with a different type of bicycle sprocket (e.g., for sprockets defining a different number of teeth or in compliance with a different standard). More specifically, in implementations of the bicycle propulsion system 100 including a first sprocket bracket 151 and a second sprocket bracket 152 in a first set of sprocket brackets 150: the first sprocket bracket 151 is further configured to engage the first bicycle sprocket, the first bicycle sprocket characterized by a first number of teeth; the second sprocket bracket 152 is further configured to engage the first bicycle sprocket, the first bicycle sprocket characterized by the first number of teeth. The bicycle propulsion system 100 can further include: a third sprocket bracket configured to attach to the first rotor element 134 in replacement of the first sprocket bracket 151 and configured to engage with a second bicycle sprocket, the second bicycle sprocket characterized by a second number of teeth different from the first number of teeth; and a fourth sprocket bracket configured to attach to the first rotor element 136 in replacement of the second sprocket bracket 152; and configured to engage the second bicycle sprocket the second bicycle sprocket characterized by the second number of teeth. In this implementation of the bicycle propulsion system 100: the annular rotor assembly 102 is further configured to transiently engage around the second bicycle sprocket in the engaged configuration of the annular rotor assembly 102 via the third sprocket bracket and the fourth sprocket bracket; the retention subassembly is further configured to translationally constrain the annular rotor assembly 102 relative to the chassis assembly 104 while the annular rotor assembly 102 is engaged around the second bicycle sprocket and the chassis assembly 104 is secured to the bicycle frame element; and the motor 162 is further configured to rotate the annular rotor assembly 102 about the center axis of the circular outer drive surface 132 via the drive subassembly, the motor 162 causing rotation of the second bicycle sprocket while the annular rotor assembly 102 is engaged around the second bicycle sprocket. Thus, the bicycle propulsion system 100 can include a kit of sprocket brackets 150 including multiple sets of sprocket brackets 150, where each set is configured to engage with a particular type of cogset. The bicycle propulsion system 100 can therefore engage with a number of different types of cogsets defining varying numbers of teeth, chain standards, or sprocket spacing by exchanging one set of sprocket brackets 150 for another set of sprocket brackets 150.

### 4. Chassis Assembly

Generally, as shown in FIGS. 3, 4, 5, 6, and 7, the bicycle propulsion system 100 includes a chassis assembly 104 that: houses the retention subassembly that translationally constrains the annular rotor assembly 102 relative to the chassis assembly 104; houses the drive subassembly that is configured to transfer power from the motor 162 to the annular rotor assembly 102; houses the electronics subsystem 180 that controls the motor 162 and executes pedal assist and safety processes; and secures the bicycle propulsion system 100 to the frame of the bicycle in order to prevent rotation of the system relative to the frame of the bicycle while the annular rotor assembly 102 is in the engaged configuration. More specifically, the bicycle propulsion system 100 includes a chassis assembly 104: configured to transiently secure to a stay of the bicycle; comprising a retention subassembly configured to translationally constrain the annular rotor assembly 102 relative to the chassis assembly 104; comprising a drive subassembly configured to engage the circular outer drive surface 132 of the annular rotor assembly 102; and a motor 162 configured to rotate the annular rotor assembly 102 about a center axis of the circular outer drive surface 132 via the drive subassembly. Additionally, in implementations where the bicycle propulsion system 100 secures to another frame element of the bicycle, the bicycle propulsion system 100 includes a chassis assembly 104: configured to transiently secure to a bicycle frame element; comprising a retention subassembly configured to translationally constrain the annular rotor assembly 102 relative to the chassis assembly 104 while the annular rotor assembly 102 is engaged around the first bicycle sprocket and the chassis assembly 104 is secured to the bicycle frame element; comprising a drive subassembly configured to engage the annular rotor assembly 102 via the circular outer drive surface 132; and comprising a motor 162 configured to rotate the annular rotor assembly 102 about a center axis of the circular outer drive surface 132 via the drive subassembly, the motor 162 causing rotation of the first bicycle sprocket while the annular rotor assembly 102 is engaged around the first bicycle sprocket. Thus, the chassis assembly 104 houses and locates the motor 162, the drive subassembly, and the retention subassembly such that the motor 162 transfers torque to the annular rotor assembly 102 via the drive belt 164. The annular rotor assembly 102 then transfers this torque to the sprocket via the set of sprocket brackets 150, thereby assisting the cyclist in applying torque to the sprocket of the bicycle.

The chassis assembly 104 includes a chassis that houses the retention subassembly, the drive subassembly, the motor 162, and the electronics subsystem 180. The chassis assembly 104 can include a chassis configured to house the abovementioned subassemblies and subsystems within a form factor that fits within the chain stay and/or seat stay of most bicycles.

In one implementation, as shown in FIGS. 3, 4, 5, 6, and 7, the chassis includes: an outboard frame 114; an outboard frame 114 parallel to the inboard frame 116; an electronics housing; and a motor cowling 113. In this implementation, the outboard frame 114 and the inboard frame 116 are separated by a set of standoffs 118 fastened to the outboard frame 114 and the inboard frame 116 via a set of threaded bores 192 in the outboard frame 114 and the inboard frame 116. Thus, the outboard frame 114 and the inboard frame 116 contain the retention subassembly and the drive subassembly between them. In this implementation, the electronics subsystem 180 and motor 162 are attached outboard of the outboard frame 114 and are housed within the electronics housing and motor cowling 113 respectively. Thus, the chassis assembly 104 can define distinct regions for the mechanical and electronic components of the bicycle propulsion system 100.

The chassis assembly 104 can include an outboard frame 114 and an inboard frame 116 stamped from aluminum, steel, or any other rigid material in order to support the retention subassembly and the drive subassembly. The chassis assembly 104 can also include an outboard frame 114 and an inboard frame 116 that define attachment points for the axles of rollers and gears (from the retention subassembly and the drive subassembly) and the motor 162 axle, thereby locating each of these components relative to each other. The chassis assembly 104 can also include an outboard frame 114 that further defines attachment points for the motor 162, the electronics subsystem 180, the electronics housing and the motor cowling 113. In one implementation, the chassis assembly 104 can include an outboard frame 114 that includes an attachment point for a sensor arm 171. In another implementation, the chassis assembly 104 can include an outboard frame 114 defining a derailleur stop 115, configured to extend into the path of a derailleur of the bicycle, shown in FIGS. 3, 4, and 5, in order to prevent the derailleur of the bicycle from shifting the bicycle chain into the sprocket with which the concentric rotor 130 is engaged, thereby preventing physical interference between the derailleur of the bicycle and/or the chain of the bicycle with the bicycle propulsion system 100. Thus, the chassis assembly 104 includes comprises a derailleur stop 115 configured to prevent a derailleur of the bicycle from shifting into the first bicycle sprocket.

The chassis assembly 104 can include an electronics housing manufactured from a hard plastic or other rigid, non-conductive material in order to prevent dirt and/or water ingress to the electronics subsystem 180 housed by the electronics housing, while also enabling wireless communication between the electronics subsystem 180 and a personal computing device of a user. The chassis assembly 104 can include an electronics housing manufactured via molding (e.g., injection molding) or additive manufacturing processes.

The chassis assembly 104 can also include a motor cowling 113 configured to surround the motor 162 and prevent physical damage to the motor 162 upon incidental impact. The motor 162 itself can include an additional waterproof housing separate from the motor cowling 113. In one implementation, the chassis assembly 104 includes a single plastic member that functions as both the electronics housing and the motor cowling 113.

The chassis assembly 104 also includes an attachment mechanism configured to transiently secure the chassis assembly 104 to a frame element of the bicycle in order to prevent rotation of the chassis assembly 104 about the annular rotor assembly 102, upon application of torque to the annular rotor assembly 102 by the chassis assembly 104. In one implementation, the chassis assembly 104 includes an attachment mechanism configured to attach the chassis assembly 104 to the drive-side chain stay of the bicycle. In this implementation, the motor 162 and motor cowling 113 can be positioned below the attachment mechanism such that, while the bicycle propulsion system 100 is engaged with the bicycle, the motor 162 and motor cowling 113 can extend outboard from the outboard frame 114 beneath the drive side chain stay of the bicycle. In this implementation, the chassis assembly 104 can include a flexible rubber or fabric strap configured to wrap around the chain stay of the bicycle and connect to the outboard face of the chassis assembly 104. However, the chassis assembly 104 can include other types of attachment mechanisms such as a clamp-or latch-based attachment mechanism.

For example, the chassis assembly 104 can include a chain stay retainer configured to stabilize the chassis assembly 104 on the bike frame. In one implementation, the motor cowling 113 rests against the chain stay, which supports the chassis assembly 104 against rotation about the axis of the rear wheel of the bicycle due to torque output by the motor 162. In another implementation, the motor cowling 113 defines a geometry offset from the chain stay of a bicycle. In this implementation, the chassis assembly 104 can include a chain stay retainer that extends from the chassis assembly 104 and is configured to abut the chain stay to resist rotation of the chassis assembly 104 caused by torque output by the motor. The chain stay retainer is additionally configured to couple to the chain stay (e.g., via a strap or hook) resist non-rotational forces on the chassis assembly 104.

In one implementation, the chain stay retainer includes: a shaft configured to adjustably extend from the chassis assembly 104; and a clasp configured to attach to the chain stay. For example, during installation of the bicycle propulsion system 100, a user can pull the chain stay retainer to extend the shaft to a length at which the clasp of the chain stay retainer contacts the chain stay. The shaft can include a spring to apply a force between the chain stay and the chassis assembly 104 to stabilize the chassis assembly 104. The clasp can rotate to fit around the chain stay. In one example, the clasp can include a latch configured: to open to accept the chain stay within the clasp; and to close around and to retain the chain stay. In another example, the chain stay retainer includes a surface configured to rest against a bottom-facing surface of the chain stay and to transfer forces from the chassis assembly 104 upwardly into the bottom-facing surface of the chain stay responsive to a torque output by the motor that drives the rear wheel of the bicycle in a forward direction. The chain stay retainer can further include a lateral adjustment mechanism to translate the clasp or shaft to laterally align with or center against the chain stay. In one implementation, the length and lateral position of the chain stay retainer are configured to establish an initial position of the chassis assembly 104 in which forces present on the chassis assembly 104 are balanced to retain the chassis assembly 104 within this initial position.

### 4.1 Retention Subassembly

Generally, as shown in FIG. 6, the chassis assembly 104 includes a retention subassembly that further includes a set of inner retaining rollers 122 and a set of outer retaining rollers 124 configured to locate the annular rotor assembly 102 within the chassis assembly 104 such that the drive belt 164 engages the circular outer drive surface 132 of the annular rotor assembly 102 while also enabling the concentric rotor 130 to rotate about its center axis (e.g., as a hub-less wheel) when torque is applied to the concentric rotor via the drive belt 164. More specifically, the chassis assembly 104 includes a retention subassembly further including a set of retaining rollers configured to translationally constrain the concentric rotor 130 subsystem as a hub-less wheel via contact with the inner retention surface 133 and the circular outer drive surface 132. Additionally, the chassis assembly 104 can include a retention subassembly that does not interfere with the teeth on the circular outer drive surface 132 of the annular rotor assembly 102, thereby reducing wear on and excess noise produced by the retention subassembly during operation of the bicycle propulsion system 100. Furthermore, the chassis assembly 104 can include a retention subassembly that enables removal of the annular rotor assembly 102 from the chassis assembly 104 such that a user may perform maintenance on the mechanical components of the bicycle propulsion system 100.

The retention subassembly includes a set of inner retention rollers configured to ride along the inner retention surface 133 of the annular rotor assembly 102 without interfering with the set of sprocket brackets 150 arranged about the inner retention surface 133 of the annular rotor assembly 102. In one implementation, the retention subassembly includes two inner retention rollers to constrain (in combination with the set of outer retention rollers) the annular rotor assembly 102 in two dimensions coplanar with the rotational plane of the annular rotor assembly 102. In another implementation, the retention subassembly includes inner retention rollers defining a slotted outer surface and defining a chamfer on either side of the slotted surface such that the inner retention rollers fit across the corresponding inner retention surface 133 of the annular rotor assembly 102, thereby laterally constraining the annular rotor assembly 102 within the slotted surfaces of the retention rollers. In this implementation, the retention subassembly can include a set of retention rollers defining asymmetrical slots such that the inboard side of the retention rollers in the set of retention rollers can clear the sprocket brackets 150 attached on the inboard side of the annular rotor assembly 102.

The retention subassembly includes a set of outer retention rollers configured to ride along a chamfered edge of the circular outer drive surface 132 of the annular rotor assembly 102. Thus, the retention subassembly contains the annular rotor assembly 102 between the set of outer retention rollers and the set of inner retention rollers. In one implementation, the retention subassembly includes a set of outer retention rollers including two outer retention rollers. In another implementation, the retention subassembly can include a set of outer retention rollers can define a slotted outer surface such that the teeth of the circular outer drive surface 132 do not come into contact with the outer retention rollers and instead the outer retention rollers contact the chamfered surface of the annular rotor assembly 102.

In one implementation, the retention subassembly includes rollers manufactured from polyoxymethylene, molybdenum-disulfide-filled nylon, or any other hardwearing plastic.

### 4.2 Drive Subassembly

Generally, as shown in FIG. 6, the chassis assembly 104 includes a drive subassembly, in order to transfer torque and power from the motor 162 to the annular rotor assembly 102. More specifically, the chassis assembly 104 can include a drive subassembly that further includes: a drive gear 166 coupled to the motor 162; a drive belt 164 configured to engage the drive gear 166 and the circular outer drive surface 132 of the annular rotor assembly 102; and a set of drive belt rollers 168 configured to maintain engagement of the drive belt 164 with the drive gear 166 and with the circular outer drive surface 132 of the annular rotor assembly 102. Thus, the drive subassembly, by including the drive belt 164 as the primary wear component of the bicycle propulsion system 100, can operate with no grease, thereby reducing maintenance overhead, while producing less noise when compared to a chain or meshed gear transmission system. Additionally, the drive belt 164 can be easily removed from the drive gear 166 and drive belt rollers 168 and replaced further improving the serviceability of the bicycle propulsion system 100.

The drive subassembly can include a drive gear 166 that shares an axle with the motor 162 and functions to transfer power to the drive belt 164. The drive belt 164 is then directed within the confines of the inboard frame 116 and the outboard frame 114, via the set of drive belt rollers 168, to conform with an arc of the circular outer drive surface 132 of the annular rotor assembly 102, while the annular rotor assembly 102 is engaged with the chassis assembly 104. In one implementation a first pair of drive belt rollers 168 located proximal to the drive gear 166 maintain tension in the drive belt 164 around the drive gear 166 while a third drive belt roller 168 extends the drive belt 164 toward an upper side of the chassis assembly 104 such that the drive belt 164 meshes with the circular outer drive surface 132 of the annular rotor assembly 102 over a large arc, thereby distributing torque transfer across a longer length of the drive belt 164 in order to further reduce maintenance frequency of the bicycle propulsion system 100. In another implementation, the drive subassembly can include a set of drive rollers 168 defining a smooth outer surface and configured to engage the smooth side of the drive belt 164 in order to direct the drive belt 164 around the drive gear 166 and around the circular outer drive surface 132 of the annular rotor assembly 102.

The drive subassembly can include a geared jockey (or idler) pulley configured to redirect and tension a section of the drive belt 164 between the pair of drive rollers 168 proximal to the drive gear 166 and the drive roller located on the upper end of the chassis assembly 104. In implementations where the chassis assembly 104 defines a different form factor than the form factor shown in FIGS. 3, 4, 5, 6, and 7, the drive subassembly can include different and/or additional drive rollers 168 and/or jockey pulleys 169 in order to position the drive belt 164 around the drive gear 166 and around a portion of the circular outer drive surface 132 of the annular rotor assembly 102.

In one implementation, the drive belt 164 includes a timing belt. Alternatively, the drive subassembly can include a friction belt. In this implementation, the drive gear 166 is replaced with a drive wheel, and the drive rollers 168 and jockey wheel are configured to increase the tension in the friction belt when compared to the timing belt.

In another implementation, the drive subassembly can include a planetary gearbox arranged between the motor and the drive gear 166 and configured to transfer torque between the drive gear 166 and the motor 162, thereby reducing backlash between the drive gear 166 and the motor 162. In this implementation, the planetary gearbox can be configured with the drive gear 166 as the sun gear in the planetary gearbox. Alternatively, the planetary gearbox can be configured with the drive gear as the ring gear in the planetary gearbox.

In yet another implementation, the drive subassembly can include a gearbox (e.g., a planetary gearbox) in replacement of the drive-belt-based system described above. In this implementation, the drive subassembly can include a gearbox arranged, within the chassis assembly 104, between the drive gear 166 and the circular outer drive surface 132, when the bicycle propulsion system 100 is in the engaged configuration. In one example, the drive subassembly can include a planetary gearbox (e.g., a single stage planetary gearbox), where the drive gear 166 is configured as a sun gear in the planetary gearbox and the carrier of the planetary gearbox is configured to transfer torque to the circular outer drive surface 132 (e.g., via a toothed concentric surface). In another example, the drive subassembly can include a planetary gearbox, where the drive gear 166 is configured as a sun gear in the planetary gearbox and the ring gear of the planetary gearbox is configured to transfer torque to the circular outer drive surface 132 of the annular rotor assembly 102.

However, the drive subassembly can include additional components configured to transfer torque between the motor 162 and the annular rotor assembly 102 via the circular outer drive surface 132.

### 4.3 Motor

Generally, as shown in FIGS. 3, 4, and 7, the chassis assembly 104 includes a motor 162 configured to transfer torque to the drive subassembly via the drive gear 166, which then transfers torque to the annular rotor assembly 102, causing rotation of the annular rotor assembly 102 and, therefore, the sprocket to which the annular rotor assembly 102 is engaged. In one implementation, the motor 162 includes a compact electric motor 162, such as a radial flux or axial flux motor 162.

The motor 162 can be coupled to the outboard frame 114 of the chassis assembly 104, thereby preventing interference between the motor 162 and the wheel of the bicycle. The motor 162 also includes an output shaft extending through the outboard frame 114 into the internal volume of the chassis assembly 104. This output shaft is coupled to the drive gear 166 of the drive subassembly and transfers power to the drive belt 164.

In one example, the motor 162 is characterized by a peak power output of greater than 1000 watts and characterized by a sustained power output of 350 watts in order to sufficiently augment the power of the cyclist over a sustained period of time. Additionally or alternatively, the chassis assembly 104 can include a motor 162 that is electronically limited (e.g., to an output of 350 watts) in order to comply with regional government regulations for motorized vehicles.

In one implementation, the chassis assembly 104 includes a clutch interposed between and configured to selectively engage the output shaft and the drive gear 166 of the drive subassembly. In this implementation, the bicycle propulsion system 100 can engage the clutch upon activation of the motor 162 and can disengage the clutch upon deactivation of the motor 162, or while coasting, in order to reduce friction on the drive train in these circumstances due to internal resistance of the motor 162 to free rotation of the output shaft. The cutch can also be configured to disengage the output shaft and the drive gear 166 by default, thereby limiting motor drag on the rear wheel when the bicycle propulsion system 100 is off or when the battery assembly 106 is discharged.

### 4.4 Sensor Subassembly

Generally, as shown in FIGS. 3, 4, 12A and 12B, the chassis assembly 104 can include a sensor subassembly 170 configured to detect power applied to the bicycle by the cyclist during operation of the bicycle propulsion system 100, thereby enabling the electronics subsystem 180 to execute closed-loop control of the motor 162 in order to assist the cyclist in propelling the bicycle based on the current effort of the cyclist. In one implementation, the sensor subassembly 170 includes a sensor arm 171 attached to a chain roller 176 configured to measure tension in the chain of the bicycle. In another implementation, the sensor subassembly 170 is integrated into the motor 162 housing and configured to measure the pressure of the motor 162 housing against a chain stay of the bicycle.

In addition to the implementations described below, the sensor subassembly 170 can estimate the power input to the bicycle by the cyclist in any other way (such as by utilizing a separate power communicating with the bicycle propulsion system 100).

### 4.4.1 Sensor Arm

In one implementation shown in FIGS. 12A and 12B, the sensor subassembly 170 can include a sensor arm 171 configured to: extend from the chassis assembly 104 to the chain of the bicycle; include a chain roller 176 configured to engaged with the chain of the bicycle; and configured to deflect based on the tension in the chain of the bicycle. More specifically, the sensor subassembly 170 includes a sensor arm 171 configured to engage with a bicycle chain via a chain roller 176 biased against the chain of the bicycle while the annular rotor assembly 102 is engaged around the first bicycle sprocket and the chassis assembly 104 is secured to the bicycle frame element; and an electronics subsystem 180 configured to detect deflection of the sensor arm 171 caused by tension in the bicycle chain and activate the motor 162 to rotate the concentric rotor 130 based on the deflection of the sensor arm 171. Thus, the sensor subassembly 170 can detect the tension in the chain of the bicycle such that the electronics subsystem 180 can estimate an applied power by the cyclist based on this detected tension and execute closed-loop control of the motor 162 based on this estimated power.

In one implementation, the sensor subassembly 170 includes a sensor arm 171 that is biased against the chain of the bicycle by a spring at one end and engages with the chain with a chain roller 176 at the opposite end. More specifically, the sensor subassembly 170 includes: a chain roller 176 coupled to the sensor arm 171 at a first end; and a biasing spring coupled to a second end of the sensor arm 171 and the chassis assembly 104 and configured to bias the chain roller 176 against the chain of the bicycle. Thus, the sensor assembly includes a sensor arm 171 configured as a lever with a sensor arm 171 axle as a fulcrum with a spring attached at one end of the sensor arm 171 biasing the opposite end toward the chain of the bicycle.

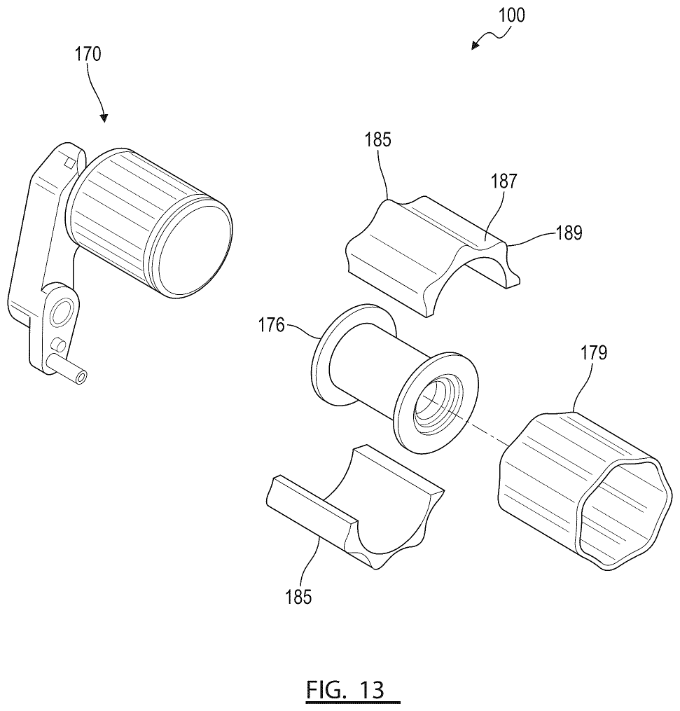

The sensor subassembly 170 further includes a chain roller 176 in order to engage with the chain and ensure that deflection of the sensor arm 171 is not due to the shape of the chain and is instead caused by the tension in the chain. Thus, the chain roller 176 can define a pitched surface configured engage the links of the chain to reduce periodic deflection of the chain roller 176 as the chain roller 176 rolls along the chain. As shown in FIG. 13, the chain roller 176 can define a pitched surface and is constructed from: a set of pitched shells 185 installed around the roller axle, the pitched shells defining a series of valleys 187 and peaks 189, where the distance between consecutive valleys and consecutive peaks is equal to the pitch of the bicycle chain. Additionally, the chain roller 176 can include a rubber sleeve 179 configured to be tensioned around the outside surface of the installed pitched shells 185.

As shown in FIG. 2, the sensor subassembly 170 can include a chain roller 176 that is biased downward toward the chain such that the angle α is less than 180 degrees. Additionally, the sensor subassembly 170 can include a chain roller 176 that extends across the full length of the cogset of the bicycle to ensure contact with the chain irrespective of the current gear selection of the cyclist. Due to the changes in the angle of the chain of the bicycle dependent on the current gear selection, the sensor assembly can be configured to remain biased against the chain for the full range of possible chain angles corresponding to the full range of possible gear selections for a typical bicycle (e.g., an 8-speed, 9-speed, 10-speed, 11-speed, 12 speed and/or a 13-speed system).

In one implementation, shown in FIGS. 12A and 12B, the sensor assembly includes a sensor arm 171 further including a pivot 178 attached to an axle of the chain roller 176, where the pivot 178 is configured to bias the chain roller 176 against the chain of the bicycle and position the roller axle 177 perpendicular to the chain of the bicycle in a first position (shown in FIG. 12A); and configured to remove the chain roller 176 from the chain of the bicycle in a second position (shown in FIG. 12B). Thus, during installation of the bicycle propulsion system 100 by a user, the user may fold the chain roller 176 such that the roller axle 177 is coplanar with the outboard frame 114 of the chassis assembly 104, thereby facilitating installation by preventing the chain roller 176 from being caught on the chain while the bicycle propulsion system 100 is moved into position at the chain stay of the bicycle.

In another implementation, the sensor assembly can include a sensor arm 171 further including: a chain roller 176 coupled to the sensor arm 171 at a first end; and a magnet 175 coupled to a second end. In this implementation, the electronics subsystem 180 (further described below) includes a Hall effect sensor proximal to the second end of the sensor arm 171 and is configured to detect deflection of the sensor arm 171 via the Hall effect sensor based on displacement of the magnet 175. Thus, by the inclusion of a magnet 175 at one end of the sensor arm 171, the bicycle propulsion system 100 can measure the deflection of sensor arm 171 due to tension in the chain of the bicycle via one or more Hall effect sensors arranged within the electronics subsystem 180 proximal to the second end of the sensor arm 171.

### 4.4.2 Pressure Sensor

In one implementation, the sensor assembly includes a pressure sensor integrated into the top side of the motor cowling 113 or electronics housing and configured to measure the pressure applied by the bicycle propulsion system 100 on the chain stay of the bicycle. Due to the arrangement of the motor cowling 113 below the chain stay of the bicycle in this implementation, an increase in torque applied by the motor 162 compared to torque applied by the cyclist increases the pressure exerted by the chassis assembly 104 on the chain stay. Therefore, by measuring the pressure in this location, the bicycle propulsion system 100 can correlate this pressure with the power input to the bicycle by the cyclist and adjust the power of the motor 162 accordingly.

### 4.5 Electronics Subsystem

Generally, as shown in FIG. 7, the chassis assembly 104 includes an electronics subsystem 180 that can further include a controller, a 6-axis inertial measurement unit (or a 3-axis accelerometer and a 3-axis gyroscope), and/or a set of Hall effect sensors. Thus, the electronics subsystem 180 can regulate power from the battery assembly 106 to the motor 162 in order to selectively apply torque to the sprocket of the bicycle in response to riding conditions detectable by the inertial measurement unit and the set of Hall effect sensors in cooperation with the sensor subassembly 170. Additionally, the electronics subsystem 180 can measure the orientation of the chassis assembly 104 relative to the ground and estimate the speed of the bicycle in order to identify whether the bicycle propulsion system 100 is operating with its safe operational envelope. Furthermore, the electronics subsystem 180 can wirelessly communicate with a mobile computation device—such as smartphone, tablet, or smartwatch worn or carried by the cyclist—in order to report ride-related data such as the current battery charge, the current level of pedal assistance, and/or the current operating power of the motor 162.

Generally, the controller can include a processor configured to execute operational envelope detection and pedal assistance algorithms of the bicycle propulsion system 100. Thus, the controller can access data from the various sensors included in the electronics subsystem 180 and from the controller and can wirelessly communicate (e.g., via an integrated wireless chip) with other I/O devices in order to execute various processes further described below.

### 4.5.1 Operational Envelope Detection

In one implementation, the electronics subsystem 180 is configured to detect whether the bicycle propulsion system 100 is within its operational envelope in order to ensure that the bicycle propulsion system 100 only applies power to the sprocket of the bicycle while the annular rotor assembly 102 is engaged with the sprocket of the bicycle, while the chassis assembly 104 is secured to a frame element of the bicycle, and while the bicycle itself is in a safely operable state (e.g., not exceeding a maximum speed or in an inoperable orientation). More specifically, the electronics subsystem 180 is configured to, in response to detecting the position of the chassis assembly 104 outside of a predefined operational envelope, halting the motor 162. Thus, the bicycle propulsion system 100 can ensure that power is cut from the motor 162 in the case of a crash or dislodgement of the bicycle propulsion system 100 from its nominal position relative to the bicycle.

In one implementation, the electronics subsystem 180 can store a set of parameters indicating the operational envelope for the bicycle propulsion system 100, such as a maximum and minimum lateral angle (i.e. inboard/outboard tilt), a maximum and minimum transverse angle (i.e. forward and backward tilt), a maximum and minimum speed, and the state of engagement of the sensor subassembly 170. In this implementation, the electronics subsystem 180 can measure the orientation of chassis assembly 104 prior to and/or during operation of the bicycle propulsion system 100 and in response to detecting that the orientation of the chassis assembly 104 exceeds the maximum lateral angle and/or the maximum transverse angle and/or is less than the minimum lateral angle or the minimum transverse angle, the electronics subsystem 180 halts and/or cuts power to the motor 162. In one example, the electronics subsystem 180 can halt the motor 162 in response to detecting a lateral angle greater than 30 degrees from vertical. Likewise, the electronics subsystem 180 can estimate the speed of the chassis assembly 104 by executing an inertial algorithm on data recorded via the inertial measurement unit and, in response to detecting a speed exceeding the maximum speed or a speed less than the minimum speed, the electronics subsystem 180 can halt the motor 162.

Additionally, the electronics subsystem 180 can measure velocity of the chassis assembly 104 in multiple dimensions and can store multiple maximum and minimum velocities, each corresponding to velocity measured in a different dimension. Thus, the electronics subsystem 180 can detect lateral movement (e.g., skidding) and halt the motor 162 to enable the cyclist to regain traction more easily between the rear wheel and the ground.

In another implementation, the electronics subsystem 180 can detect whether the sensor arm 171 is engaged with the chain by detecting whether the sensor arm 171 is deflected by less than a threshold deflection caused by a tensionless chain. For example, the electronics subsystem 180 can include a predefined deflection corresponding to a state where the sensor arm 171 is not engaged with the chain and is fully biased (e.g., by the biasing spring) against a hard stop integrated within the chassis assembly 104. Therefore, in response to detecting that the chain is disengaged with the chain roller 176 of the sensor arm 171 and the tension of the chain is no longer detected by the electronics subsystem 180, the electronics subsystem 180 can halt the motor 162.

### 4.5.2 Adaptive Pedal Assistance

Generally, the electronics subsystem 180 can execute an adaptive pedal assistance algorithm based on the estimated power output by the cyclist (e.g., via measurement of chain tension by the sensor subassembly 170, via integration with a power meter, or via a pressure sensor detecting the force exerted by the chassis assembly 104 on the chain stay of the bicycle), the current gear selection of the cyclist, the cadence of the cyclist, the estimated inclination of the bicycle, and/or the estimated speed of the bicycle in order to selectively apply additional power to the sprocket of the bicycle without substantially altering the handling of the bicycle or the operational experience of the bicycle when compared to manual operation of the same bicycle. More specifically, the electronics subsystem 180 is configured to estimate the power output by the cyclist based on deflection of the sensor arm 171 caused by tension in the bicycle chain and modify the output power of the motor 162 based on this measured deflection; estimate the gear selection of the bicycle based on step changes in the deflection of the sensor arm 171; estimate the inclination of the bicycle relative to the ground plane based on data from the inertial measurement unit; and estimate the speed of the bicycle based on an estimated cadence of the cyclist and the gear selection of the bicycle.

In one implementation, the electronics subsystem 180 can store a predefined lookup table (based on empirical data) or a predefined function correlating deflection of the sensor arm 171 to the power output by the cyclist. In this implementation, the electronics subsystem 180 can receive (e.g., via an associated application running on a smartphone) the gear configuration (e.g., brand cassette and chainring selection) of the bicycle. The electronics subsystem 180 can then select a function or lookup table corresponding to the gear configuration of the bicycle.

Alternatively, the electronics subsystem 180 can initiate a calibration procedure based on input from a mobile computation device (e.g., via an associated application running on a smartphone) in order to associate the power output by the cyclist with deflection of the chain. During the calibration procedure, the electronics subsystem 180 can measure the deflection of the chain of the bicycle as the cyclist is instructed to perform a series of hard and easy efforts. Based on these data, the electronics subsystem 180 can then correlate the deflection of the chain of the bicycle with maximum and minimum efforts of the cyclist.

In another implementation, the electronics subsystem 180 can: store a model, map, or lookup table that links predefined deflection ranges of the sensor arm to a particular sprocket selection in the rear cogset; measure deflection of the sensor arm 171; and predict the gear selection of the bicycle based on this model and the measured deflection. Alternatively, the electronics subsystem 180 can execute a calibration procedure by: for a first sprocket in the cogset of the bicycle, prompting the cyclist to shift into the first sprocket and pedal (e.g., at variable effort levels); recording deflection of the sensor arm 171 for a first duration; and repeating this procedure for successive sprockets of the cogset of the bicycle.

In yet another implementation, the electronics subsystem 180 can: execute frequency analysis on the measured deflection of the sensor arm 171 over time to estimate the cadence of the cyclist; and modify the power output by the motor 162 based on the cadence of the cyclist. For example, in response to estimating a low cadence of the cyclist (e.g., less than 70 rotations-per-minute), the electronics subsystem 180 can increase the power output of the motor 162. Alternatively, in response to estimating a high cadence of the cyclist (e.g., greater than 100 rotations-per-minute), the electronics subsystem 180 can decrease the power output of the motor 162. Thus, the electronics subsystem 180 leverages the cyclic nature of the torque applied by the cyclist during each pedal stroke to estimate the cadence of the cyclist and can modify the power output of the motor 162 based on this estimated cadence.

In another implementation, the electronics subsystem 180 can estimate the inclination of the bicycle by calculating, via the inertial measurement unit, the transverse orientation of the chassis assembly 104. Based on a known orientation of the chassis assembly 104 while the bicycle is on flat ground, the electronics subsystem 180 can calculate the inclination of the bicycle and modify the power output of the motor 162 based on this inclination.

In another implementation, the electronics subsystem 180 can implement dead reckoning techniques to estimate the speed of the speed of the bicycle based on inertial data output by the inertial measurement unit. Additionally or alternatively, the electronics subsystem 180 can calculate the speed of the bicycle directly based on the estimated cadence of the cyclist, the estimated gear selection of the bicycle, and a known wheel diameter of the bicycle. In yet another implementation, the electronics subsystem 180 can: measure a rotational speed of the motor 162 (e.g., via a rotational encoder, via Hall effect sensors proximal to the motor, or via measurement of the counter-electromotive force of the motor 162); and estimate the speed of the bicycle based on the measured rotational speed of the motor 162, the gear ratio between the motor 162 and the wheel of the bicycle, and the known wheel diameter of the bicycle.

Upon calculating and/or estimating each of the above values, the electronics subsystem 180 can input these values into a tuned function in order to calculate an output power for the motor 162. The electronic subsystem 180 then communicates this output power to the motor 162; and draws power from the battery assembly 106 sufficient to operate the motor 162 at this output power. In one implementation, the electronics subsystem 180 is configured to calculate an output power of zero upon detecting a speed of the bicycle greater than a threshold speed in order to comply with regulations on electric bicycles.

Thus, the electronics subsystem 180 can be configured to: calculate a cadence of the bicycle based on periodic deflection of the sensor arm 171; calculate a speed of the bicycle via the six-axis inertial measurement unit; identify a current gear ratio of the bicycle based on the speed of the bicycle and the cadence of the bicycle; and drive the motor 162 based on the current gear ratio of the bicycle.

### 4.5.3 Automatic Backpedaling Assistance

In one implementation, the electronics subsystem 180 can execute automatic backpedaling assistance to enable the bicycle equipped with the bicycle propulsion system 100 to mimic the pedaling dynamics of a standard bicycle. Because the annular rotor assembly 102, the drive subassembly, and the motor 162 all impose additional resistance (e.g., in the form of friction, additional rotational weight) onto the sprocket when the motor 162 is not powered, without automatic backpedaling assistance, the cyclist may be unable to backpedal the bicycle. Thus, upon detecting that the cyclist is no longer pedaling (e.g., based on the chain tension estimated via the sensor arm 171), the electronics subsystem 180 can cause the motor 162 to reverse direction at a predetermined speed, thereby enabling the user to pedal backward up to a threshold cadence corresponding to the predetermined backpedaling speed.

### 5. Battery Assembly

Generally, as shown in FIG. 1, the bicycle propulsion system 100 can include a battery assembly 106 connected to the chassis assembly 104 by a power cable 182 (or integrated directly with the chassis assembly 104) in order to supply power to the electronics subsystem 180 and the motor 162). In one implementation, the bicycle propulsion system 100 is configured to: fit within a standard bicycle bottle holder; supply power to the motor 162; and supply power to the electronics subsystem 180. In this implementation, the battery assembly 106 also includes a power cable 182 electrically coupling the battery assembly 106 to the electronics subsystem 180 and the motor 162. Thus, by including a battery assembly 106 that fits within a standard bicycle bottle holder, the bicycle propulsion system 100 can be more easily installed on any bicycle already including a standard bottle holder.

In one implementation, the bicycle propulsion system 100 includes a battery assembly 106 further including a set of modular battery packs configured to engage with each other and configured to fit within a standard bicycle bottle holder. This modular battery assembly 106 enables the user to bring only the battery capacity needed for a planned trip and reduce the total weight of the bicycle propulsion system 100 in accordance with the needed capacity. In one example, the battery assembly 106 can include a set of cylindrical modular batteries configured to connect at the top and bottom of the cylinder and configured to slide into a standard bicycle bottle holder. Additionally, in this example the battery assembly 106 can include a topmost cylindrical battery configured to engage the power cable 182 and a bottommost cylindrical battery defining a flat bottom such that the bottommost cylindrical battery rests evenly at the bottom of a standard bicycle bottle holder. In another example, the battery assembly 106 can include an exterior battery shell (e.g., in the form of a hollow cylinder) and configured to support a set of modular batteries within the exterior battery shell. In this example, the exterior battery shell can include an integrated electronic battery management unit connected to each modular battery in the set of modular batteries in order to modulate power drawn from each modular battery in the set of modular batteries. The exterior battery shell can be configured to secure the set of modular batteries within the exterior battery shell via friction or via a set of mechanical locks or latches. Each modular batter in the set of modular batteries can include a female surface and a male surface on the top and bottom of the modular battery respectively (or vice versa) in order to aid in engaging each modular battery with other modular batteries in the set of modular batteries. Additionally, in this example, the topmost modular battery in the set of modular batteries an include a connector or adapter configured to electrically couple the battery assembly 106 to the power cable 182.

In another implementation, the bicycle propulsion system 100 can include a battery assembly 106 integrated with the chassis assembly 104 or configured to attach to the chain stay, seat stay, seat tube, downtube, or top tube of the bicycle. In each implementation, the bicycle propulsion system 100 can include a power cable 182 of an appropriate length to connect the battery assembly 106 the chassis assembly 104. Alternatively, the bicycle propulsion system 100 can include a battery assembly 106 that directly connects the chassis assembly 104 without a power cable 182.

### 6. Throttle Assembly

In one variation shown in FIG. 1, the bicycle propulsion system 100 includes a throttle assembly 108. For example, the throttle assembly 108 can include a set of buttons and can transmit button selections to the controller. The controller can then: adjust a relationship between chain tension (or cyclist output power) and torque or power output of the motor; or switch the bicycle propulsion system 100 on and off based on selections of these buttons. The throttle assembly 108 can additionally or alternatively display system data received from the controller, such as battery level, assistance level, and/or ride statistics.

### 7. Chainring-Mounted Variation

In one variation, the bicycle propulsion system 100 is configured to engage with one or more front sprockets (i.e. chainrings) of the bicycle (as opposed to the rear cogset) in order to convert bicycles without sufficient clearance in proximal to the rear triangle of the bicycle or mountain bikes with cogset sprockets above a threshold diameter to an electrically assisted bicycle. In this variation, the bicycle propulsion system 100 can include a annular rotor assembly 102 configured to engage with an innermost set of chainrings of the bicycle and a chassis assembly 104 configured to rest between the seat tube and the downtube of the bicycle or configured to attach below the downtube of the bicycle. Alternatively, in this variation, the bicycle propulsion system 100 can include a annular rotor assembly 102 configured to engage with the outermost chainring of the bicycle. This variation of the bicycle propulsion system 100 can include the same set of components described above with respect to the rear cogset variation that instead defines a form factor configured to fit within the bottom bracket region of the bicycle.

### 8. Examples

In one example, a cyclist may install the bicycle propulsion system 100 on a right side or “on-side” of a bicycle in order to convert her standard (e.g., analog, acoustic, or push) road bicycle into an electric bicycle to facilitate commuting or to traverse more difficult terrain. The cyclist can then easily remove the bicycle propulsion system 100: to use the bicycle for exercise; to comply with legal restriction on electric bicycles in a particular area; to prevent theft of the bicycle propulsion system 100 while parking her bicycle; or for any other reason. Likewise, the cyclist can easily reinstall the bicycle propulsion system 100 whenever she desires pedal assistance.

In another example, a bikeshare operator may install an instance of the bicycle propulsion system 100 on a right side or “on-side” of each bicycle in a fleet of bicycles in order to electrically assist users of this fleet of bicycles and improving the utility of these bicycles to commuters in an operational region. Upon mechanical failure of any bicycle propulsion system 100, the bikeshare operator can remove the bicycle propulsion system 100 from the affected bicycle and replace the bicycle propulsion unit with a functional bicycle propulsion system 100 while the original bicycle propulsion system 100 undergoes repairs. Therefore, by installing the bicycle propulsion system 100 on the bicycle, as opposed to a pedal assistance system integrated with the bicycle, the bikeshare operator can minimize downtime in the fleet of electric pedal assist bicycles.

### 9. Hub Adapter Variation: Disk Brake+Off-Side Integration

In one variation, the bicycle propulsion system 100 is configured to mount to and/or around the rear disk brake rotor of a disk brake bicycle in order to vacate the innermost sprocket, thereby enabling use of the entire cogset of the bicycle. In this variation, the motor drives the rotation of the rear disk brake rather than the progression of the chain, as described above.

Generally, in this variation, the bicycle propulsion system 100 can: transiently locate on a left side or “off-side” of the bicycle opposite the chain and cogset; and interface with a rear disk brake located on the left side of the bicycle, such as via an hub adapter 190. In particular, the bicycle propulsion system 100 can include: an hub adapter 190 configured to intransiently install on a rear axle of a bicycle (e.g., a rear wheel hub of the bicycle) and apply torque to the rear axle through a rear disk brake of the bicycle; a rotor configured to transiently couple to the hub adapter 190; a chassis assembly 104 configured to transiently couple to a frame element of the bicycle (e.g., a left chain stay of the bicycle, a left seat stay of the bicycle); and a motor arranged proximal the frame element of the bicycle and/or within the chassis assembly 104 and configured to drive the rotor, thereby generating additional torque about the rear axle of the bicycle, through the rear disk brake, and assisting a rider operating the bicycle.

### 9.1 Hub Adapter

The hub adapter 190, shown in FIGS. 14, 24, and 25, is configured to mount to a rear wheel hub of a bicycle. The hub adapter 190 can attach to the rear wheel hub semi-permanently (or “intransiently”) via a set of threaded fasteners and define an engagement surface for the annular rotor assembly 102. The annular rotor assembly 102 transiently engages the hub adapter 190 to enable electric bicycle propulsion. The annular rotor assembly 102 and chassis assembly 104 are removeable from the hub adapter 190 and thus the rear wheel hub to enable a user: to remove and reinstall the bicycle propulsion system 100; and/or to transition the bicycle propulsion system 100 from one bicycle to a second bicycle.

In one implementation, the hub adapter 190 can define a target thickness configured to laterally offset the annular rotor assembly 102, along the rear axle, from the rear disk brake-such that the annular rotor assembly 102 of the bicycle propulsion system 100 can cooperate with the rear disk brake to rotate the rear axle in order to maintain the functionality of the brake caliper. For example, the annular rotor assembly 102 is laterally offset from the rear disk brake by the thickness of the hub adapter 190 in order to avoid interference between the annular rotor assembly 102 and the brake caliper, while the brake caliper contacts the rear disk brake to slow rotation of the rear wheel.

### 9.1.1 Engagement Features

The hub adapter 190 defines a set of engagement features (e.g., a set sprocket-like teeth) configured to engage with the hub adapter 190 brackets of the annular rotor assembly 102 and to support the annular rotor assembly 102 in a closed configuration. In one implementation, the sprocket brackets can include an angular geometry (e.g., a bend) to maintain the perimeter of the annular rotor assembly 102 at a lateral offset distance from the rear disk brake. For example, the sprocket brackets can extend away from the plane defined by the annular rotor assembly 102 to contact the hub adapter 190.

### 9.1.2 Segments

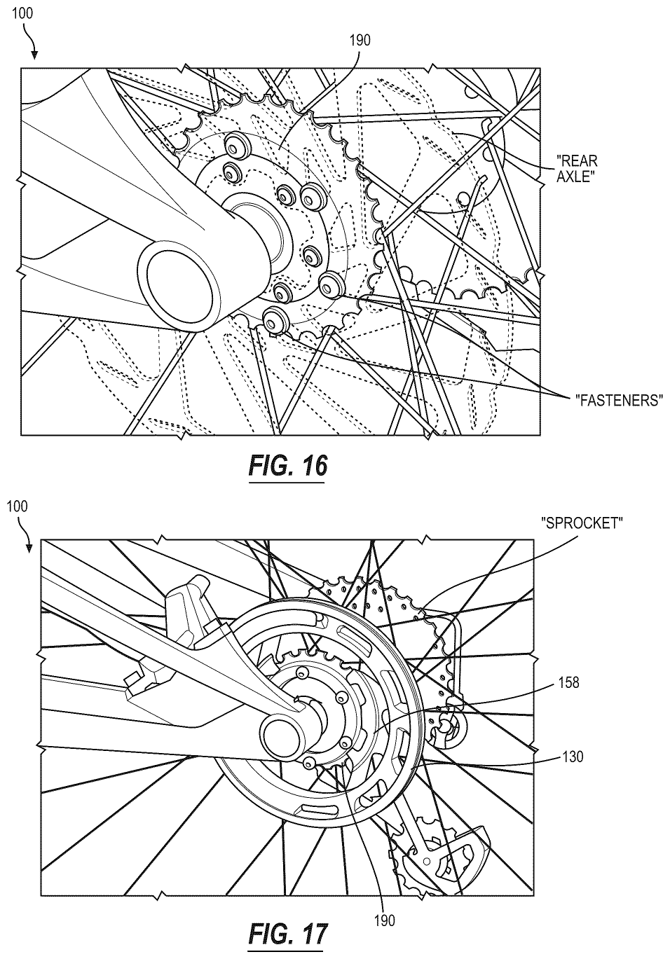

In one implementation, the hub adapter 190 can include two segments, shown in FIGS. 14, 15, and 16, configured to encircle the rear wheel hub. The hub adapter 190 defines: a front face 191 defining a first set of threaded bores 192, distributed about the front face 191 and configured to receive a set of fasteners (e.g., pins, pegs, screws) to transiently couple the front face 191 of the hub adapter 190 to the rear disk brake of the bicycle; and a rear face 193 opposite the front face 191 and defining a through-bore 194 configured to pass the rear axle of the rear wheel of the bicycle. Thus, the hub adapter 190 installs to the rear wheel hub by encircling the rear axle and mounts the hub adapter segments to the rear disk brake via a set of fasteners threaded through cut outs of the disk brake and threaded bores 192 of the hub adapter segments.

In one variation, the two segments of the hub adapter 190 can include a connection bore configured to receive a fastener to couple the two segments around the rear axle. In this variation, the two segments of the hub adapter 190 fasten together around the rear axle. The hub adapter 190 can further include a visual indicator configured to: constrain an orientation of the hub adapter 190 relative to the rear axle of the rear wheel of the bicycle; and guide installation of the two segments around the rear axle by a user.

### 9.1.3 Single Annulus

In one implementation, the hub adapter 190 defines a single annulus configured to install onto a rear wheel hub and/or the rear disk brake. The through-bore 194 of the hub adapter 190 defines a diameter greater than a diameter of a wheel axle and less than a diameter of the hub adapter 190. Thus, the through-bore 194 of the hub adapter 190 is sized to enable a user to pass the rear axle running from a rear wheel hub on the right side of the bicycle to a chain stay on the left side of the bicycle. For example, during installation, a user can remove the rear wheel of the bicycle and slide the hub adapter 190 onto the rear axle, passing the rear axle through the through-bore 194 of the hub adapter 190, to intransiently install the hub adapter 190 around on the rear axle. Then, the user can couple the hub adapter 190 to the rear disk brake or to the rear wheel hub via a set of fasteners threaded through the set of threaded bores 192 of the hub adapter 190.

### 9.2 Kit of Hub Adapters

In one implementation, the bicycle propulsion system 100 can include an installation kit of a set of hub adapters 190 (and/or set of hub adapter segments) defining a variety of threaded bore positions to align with various cutout geometries and sizes of disk brakes in order to mount the hub adapter segments around the rear axle and to the rear disk brake.

In one variation, the rear disk brake can include a set of cutouts angularly offset by a pitch angle (e.g., 30 degrees, 20 degrees). Accordingly, the front face 191 of the hub adapter 190 can define the first set of threaded bores 192—distributed about the front face 191 and angularly offset by the pitch angle—configured to receive a set of fasteners (e.g., pins, pegs, screws) to transiently couple the front face 191 of the hub adapter 190 to the rear disk brake of the bicycle.

In one example, a rear disk brake of a bicycle can include six cutouts angularly offset by a 30-degree pitch angle. In this example, a user can select an hub adapter 190 with six threaded bores 192 (or two hub adapter segments defining a total of six threaded bores 192) including a 30-degree pitch angle to align the threaded bores 192 of the two hub adapter segments with the six cutouts of the rear disk brake. In another example, the rear disk brake can include nine cutouts angularly offset by a 20-degree pitch angle, and therefore the user can select an hub adapter 190 including nine threaded bores 192 including a 20-degree pitch angle.

### 9.2.1 Stabilizing Components

In one implementation, the installation kit can further include a set of stabilizing components configured to: offset the annular rotor assembly 102 from the rear disk brake; and align the annular rotor assembly 102 parallel to the rear disk brake. In particular, the installation kit can include a set of bushings configured to: mount to the rear axle; and define a mounting surface to mesh with (e.g., interface with) the hub adapter 190. The set of bushings can include bushings of various inner diameters to match an axle diameter of a bicycle and bushings of various outer diameters to match a diameter of the hub adapter 190. Thus, the set of bushings can enable a user to mount the hub adapter 190 to bikes of varying geometries and to stabilize the hub adapter 190 on the rear axle of the bicycle.

In one variation, the installation kit can include a set of shims configured to mount to the rear disk brake and the annular rotor assembly 102. Each shim defines a thickness proportional to a target offset distance between the annular rotor assembly 102 and the rear disk brake in order to offset the annular rotor assembly 102 from the rear disk brake, as described above. Each shim further defines a set of threaded bores 192 configured to receive a set of fasteners to attach the shim to the annular rotor assembly 102 and the rear disk brake (e.g., by aligning threaded bores 192 of the shim with cutouts of the rear disk brake and with threaded bores 192 of the annular rotor assembly 102). The user can install multiple shims between the rear disk brake and the annular rotor assembly 102 to align a plane of the annular rotor assembly 102 parallel to a plane of the rear disk brake. The user may then couple each shim to the rear disk brake via a set of fasteners threaded through the set of threaded bores 192 of each shim, shown in FIG. 19.

### 9.3 Frame Connection

Generally, the chassis assembly 104 can mount to a frame element, such as a left side chain stay and/or a left side seat stay of a bicycle via a set of attachment mechanisms. In particular, the set of attachment mechanisms can include a torque arm 173, a central connector, and/or or a set of clamps.

In one implementation, the chassis assembly 104 is mounted to a frame element of the bicycle via a torque arm 173. The torque arm 173 defines a first end coupled to the chassis assembly 104 and a second end configured to contact the chain stay and/or seat stay, as shown in FIGS. 18 and 19. The torque arm 173 further defines a shaft extending vertically from the chassis assembly 104 arranged between the spokes of the rear wheel and the chain stay and/or seat stay. The shaft defines a set of reliefs configured to: rest against the chain stay and/or seat stay to stabilize the chassis assembly 104 by exerting force against the chain stay and/or seat stay; and prevent the shaft from translating vertically relative the chain stay and/or seat stay due to torque on the chassis assembly 104 from the rotation of the motor.

In one variation, the torque arm 173 includes a set of straps, hooks, or latches to otherwise secure the torque arm 173 to the chain stay and/or seat stay of the bicycle. A user can define the position of the set of straps, hooks, or latches to align with the chain stay and/or seat stay of different bicycles, such as via adjusting a set screw defining the position of the straps, hooks, or latches along the shaft of the torque arm 173.

In another implementation, the chassis assembly 104 is mounted to a frame element of the bicycle via a central connector. The central connector includes a first end coupled to the chassis assembly 104 and a second end configured to couple to the rear wheel hub. The second end of the central connector can include a hook and/or latch to attach the second end to the central axis of the wheel hub. The central connector: defines a rigid shaft extending from the chassis assembly 104 to the rear axle; and stabilizes the bicycle propulsion system 100 relative to the rear wheel hub by defining an offset radius from the center of the axle to the chassis assembly 104. The length of the central connector defines the offset radius to maintain the axle the offset radius away from the chassis assembly 104 to maintain alignment of the chassis assembly 104 about the rear disk brake.

### 9.4 Disk Brake Integrations

In one implementation, the annular rotor assembly 102 further includes: a first hub adapter bracket 157 extending inwardly from the first rotor element 134 and defining a first set of retention features 153 configured to engage and retain the set of external engagement features 195 of the hub adapter 190 in the closed configuration; and a second hub adapter bracket 158 extending inwardly from the first rotor element 136 and defining a second set of retention features 153 configured to engage and retain the set of external engagement features 195 of the hub adapter 190 in the closed configuration. Further, the first rotor element 134 and the first hub adapter bracket 157 are physically coextensive and the first rotor element 136 and the second hub adapter 190 are physically coextensive.

In one variation, the first hub adapter bracket 157 includes: an additional set of retention features 153 configured to insert between and to engage a first subset of external engagement features 195 of the hub adapter 190 in the closed configuration and interdigitated between the first set of retention features 153; a first set of outboard retaining teeth 154 arranged on left sides of the first set of retention features 153; and a second set of outboard retaining teeth 154 arranged on right sides of the second set of retention features 153 and configured to laterally constrain the first hub adapter bracket 157 on the hub adapter 190. The second hub adapter bracket 158 includes: an additional set of retention features 153 configured to insert between and to engage a second subset of external engagement features 195 of the hub adapter 190 in the closed configuration and interdigitated between the second set of retention features 153; a third set of outboard retaining teeth 154 arranged on left sides of the second set of retention features 153; and a fourth set of outboard retaining teeth 154 arranged on right sides of the fourth set of retention features 153 and configured to laterally constrain the second hub adapter bracket 158 on the hub adapter 190, shown in FIGS. 8 and 9.

In another variation, the annular rotor assembly 102 can include a center axle to replace the through-axle of the disk brake assembly and can therefore be driven via a direct power transmission between the motor 162 and the through-axle. Alternatively, the annular rotor assembly 102 can include a circular outer drive surface 132 and the bicycle propulsion system 100 can apply torque to this circular outer drive surface 132 via the drive subassembly, as described above.

In yet another variation, the bicycle propulsion system 100 includes a hub adapter 190 configured to couple to a rear axle of a bicycle and offset from a rear disk brake on the rear axle of the bicycle. The hub adapter 190: mounts to the rear axle; defines a set of external engagement features 195 (e.g., a set of teeth) configured to interface with a set of retention features 153 defined by the annular rotor assembly 102; couples to the rear wheel hub and/or the rear disk brake; and is configured to apply torque to the rear axle through the rear disk brake of the bicycle (e.g., rotate the hub adapter 190 with the rear disk brake). The hub adapter 190: defines a target thickness; laterally offsets the annular rotor assembly 102 from the rear disk brake by this target thickness; and prevents interference or collision between the annular rotor assembly 102 and a brake caliper of the rear disk brake.

Therefore, the bicycle propulsion system 100 is configured to mount to multiple types of bicycles characterized by varying geometries and sizes. For example, the bicycle propulsion system 100 is configured to couple to the sprocket of an “on-side” of a road bicycle and to couple to a hub adapter 190 of the “off-side” of an offroad bicycle. The configurability of the bike propulsion system allows a user to interchange a single bike propulsion system 100 between a collection of bicycles associated with the user.

### 9.5 Configurations

In a first configuration, the hub adapter 190 is removably fastened to a rear disk brake of a bicycle and the annular rotor assembly 102 is coupled to the hub adapter 190. For example, the rear axle runs through the through-bore 194 of the rear face 193 of the hub adapter 190; the front face 191 of the hub adapter 190 is removably fastened to the rear disk brake of the bicycle; the annular rotor assembly 102 is concentric with the rear disk brake of the bicycle and engaged with external engagement features 195 of the hub adapter 190; and the chassis assembly 104 is coupled to the frame element of the bicycle and proximal the annular rotor assembly 102.

In a second configuration, the hub adapter 190 is removably fastened to a rear disk brake of a bicycle and the annular rotor assembly 102 is mounted to the rear disk brake of the bicycle and the hub adapter 190. For example, the rear axle runs through the through-bore 194 of the rear face 193 of the hub adapter 190; the front face 191 of the hub adapter 190 is removably fastened to the rear disk brake of the bicycle; the annular rotor assembly 102 is mounted to the rear disk brake of the bicycle and engaged with external engagement features 195 of the hub adapter 190; and the chassis assembly 104 is coupled to the frame element of the bicycle and proximal the annular rotor assembly 102.

### 9.6 Drive Subassembly

Furthermore, the chassis assembly 104 of the bicycle propulsion system 100 can include a set of aligning rollers similar to the set of retaining rollers 124 and can be removed from the chassis assembly 104 after installation of the bicycle propulsion system 100. Each aligning roller is configured to contact the rotor within the chassis assembly 104 to align the rotor relative to the chassis assembly 104. The aligning roller thereby prevents rubbing of the rotor on the inside surface of the chassis assembly 104 and maintains the rotor in-plane with the chassis assembly 104.

In one implementation, the first rotor element 134 and the first rotor element 136 of the chassis assembly 104 form a circular outer drive surface 132 including a toothed gear. The toothed gear is configured to mesh with a toothed gear arranged on the motor to enable rotation of the rear axle through the rear disk brake. For example, the first rotor element 136 cooperates with the first rotor element 134 to form the circular outer drive surface 132, including a continuous toothed gear, around and concentric with the rear disk brake in the closed configuration; and the drive subassembly includes a corresponding toothed gear arranged on an output shaft of the motor and configured to mesh with the continuous toothed gear formed by the first rotor element 134 and the first rotor element 136 in the closed configuration. Thus, the toothed gears cooperate to enable rotation of the rear axle through the rear disk brake when the motor is actuated by the controller.

### 9.6.1 Linked Arm

In one variation, the drive subassembly includes a linked arm 165 configured to locate the motor and electronics subsystem proximal a left side chain stay of the bicycle or proximal a bottle holder coupled to the frame of the bicycle. The linked arm 165 includes a set of links and a joint 168 interposed between the set of links.

Furthermore, the linked arm 165 includes: a proximal link 166 defining a first end coupled to the chassis assembly 104 and a second end coupled to a joint 168; a distal link 167 defining a third end coupled to the joint 168 and a fourth end coupled to the motor; and the joint 168 interposed between the proximal link 166 and the distal link 167, configured to pivot about a pivot axis (e.g., a Z-axis) orthogonal to the proximal link 166 and the distal link 167, and configured to constrain movement of the articulable arm to the pivot axis during operation of the bicycle. Thus, the linked arm 165 can locate a top face of the motor and/or electronics subsystem on a bottom face of the left side chain stay of the bicycle such that the left side chain stay supports a total weight of the drive subassembly.

### 9.6.2 Power Transmission Assembly

Generally, the bicycle propulsion system 100 includes a power transmission assembly 160 in replacement of the drive subassembly. The power transmission assembly 160 includes the motor and the linked arm 165 and is configured to transfer torque, output by the motor, to the timing belt to rotate the rear axle via the first hub adapter bracket 157 and the second hub adapter bracket 158 in the closed configuration. In particular, the linked arm 165 includes a set of drive pulleys and a set of timing belts configured to mesh with the timing belt defined by the circular outer drive surface 132 of the chassis assembly 104. The timing belt of the chassis assembly 104 defines a width (e.g., 20 mm) greater than the width (e.g., 10 mm) of the timing belt of chassis assembly 104 in the sprocket-mounted configuration of the bicycle propulsion system 100, as described above.

In one implementation, the proximal link 166 includes a first set of drive pulleys and a first timing belt configured to run between the set of drive pulleys and mesh with the first timing belt of the chassis assembly 104. The distal link 167 is mounted to the motor and includes: a second set of drive pulleys; and a third timing belt configured to run between the second set of drive pulleys. The joint 168 is interposed between the first link and the second link and configured to pivot the articulated arm about a pivot axis orthogonal to the first link and the second link.

In one variation, the linked arm 165 includes: a first drive pulley proximal the first end of the proximal link 166; a second drive pulley proximal the second end of the proximal link 166; and a first timing belt configured to run between the first drive pulley and the second drive pulley and mesh with the circular outer drive surface 132. The linked arm 165 further includes a third drive pulley proximal the third end of the distal link 167; a fourth drive pulley proximal the fourth end of the distal link 167 and coupled to an output shaft of the motor; and a second timing belt configured to mesh with the third drive pulley and the fourth drive pulley and transfer torque output by the motor through the first timing belt and into the circular outer drive surface 132. Thus, the power transmission assembly 160 transfers torque output by the motor, through the third timing belt, through the second timing belt, and into the first timing belt to rotate the rear axle via the first hub adapter bracket 157 and the second hub adapter bracket 158 in the closed configuration.

In another variation, the linked arm 165 includes: a first drive shaft; a second drive shaft coupled to the motor; and a set of miter gears (e.g., beveled gears, drive gears, transmission gears). The set of miter gears: is pivotably coupled to the first drive shaft and the second drive shaft; defines a shaft angle within a target shaft angle range (e.g., between 30 degrees and 90 degrees) to angularly offset the first drive shaft from the second drive shaft; and is configured to transfer torque output by the motor from the second drive shaft, to the first drive shaft, and into the first timing belt. Thus, the power transmission assembly 160 transfers torque output by the motor, through the second drive shaft, the first drive shaft, and the timing belt second to rotate the rear axle via the first hub adapter bracket 157 and the second hub adapter bracket 158 in the closed configuration.

### 9.7 Controls

Since the bicycle propulsion system 100 is located on the “off-side” of the bicycle opposite the chain, the chain may be inaccessible to the bicycle propulsion system 100 or to a tension sensor arranged on or within the chassis assembly 104. Therefore, the bicycle propulsion system 100 can include a remote chain sensor 172 configured to: locate on the chain stay; contact the bicycle chain; and output a signal representing tension on the bicycle chain.

In one implementation, the chain sensor 172 can: mount along a right chain stay or right seat stay of the bicycle; include an angular position sensor; include a roller configured to ride on the chain; include a spring-loaded arm extending from the angular position sensor and configured to bias the roller against an upper section of the chain; and include a wired or wireless communication module configured to transmit an analog or digital signal representing the angular position of the spring-loaded arm to the controller. As described above, greater pedaling force applied by a user may increase tension on the upper section of the chain between the front and rear cogsets, which may resist downward force applied by the chain sensor 172 on the chain via the roller, thereby deflecting the roller upwardly. The chain sensor 172 can thus detect this deflection and output a signal representing the change in vertical position of the roller or a corresponding force applied by the chain onto the roller, such as based on a stored spring constant of a spring coupled to the spring-loaded arm.

Additionally, the bicycle propulsion system 100 can include a remote throttle assembly, such as configured to mount a handlebar of the bicycle and to transmit a throttle signal to the controller via wired or wireless communication protocol. The controller can then actuate the motor based on a throttle position received from the remote throttle assembly. In one example, the remote throttle: includes a throttle lever rotatable by a user to indicate a target output torque or a target wheel speed; and outputs a throttle position of the throttle lever to the controller. Accordingly, the controller modulates (e.g., pulse-width modulate) an output torque or speed of the motor based on this throttle position.

Alternatively, the throttle assembly 108 can include a user interface such as a display and a set of buttons. The user interface can transmit button selections to the controller. The controller can then: adjust a relationship between torque or power output of the motor; or switch the bicycle propulsion system 100 on and off based on selections of these buttons. The throttle assembly 108 can additionally or alternatively display system data received from the controller, such as battery level, assistance level, and/or ride statistics. For example, the user interface, such as a set of buttons, is coupled to a handlebar of the bicycle and the controller is arranged on the linked arm 165. The controller: actuates the motor to rotate the annular rotor assembly 102 in response to a first user input (e.g., a first button selection) via the user interface; and halts the motor to cease rotation of the annular rotor assembly 102 in response to a second user input (e.g., a second button selection) via the user interface.

In another implementation, the bicycle propulsion system 100 can include a pressure sensor configured to: measure a foot pressure on the pedal; and transmit the foot pressure data to an external device (e.g., a smartphone of the user via Bluetooth). The bicycle propulsion system 100 can include: a gyroscope; an accelerometer; a magnetometer; and/or a barometer such as to read the pedal position. The controller can then adjust a relationship between torque or power output of the motor based on pedal positions.

### 9.8 Installation

In one example, in order to mount the bicycle propulsion system 100 to a bicycle including a rear disk brake, a user may: position the two segments of the hub adapter 190 between the rear disk brake and the rear wheel; and mounts the hub adapter 190 to the rear axle by placing a set of fasteners within the threaded bores 192 of the hub adapter 190. The set of fasteners connect the hub adapter 190 to the disk brake via a set of cutouts of the rear disk brake. In another example in which the hub adapter 190 is a single annular piece, the user can remove a rear wheel of the bicycle and slide the annular hub adapter 190 piece onto the rear axle between the rear disk brake and the rear wheel.

Once the hub adapter 190 is attached to the rear axle, the user can open the annular rotor assembly 102 (e.g., via the hinge connecting the components of the annular rotor assembly 102) and fit the annular rotor assembly 102 about the hub adapter 190. The user can align the annular rotor assembly 102 such that the set of retention features 153 of each hub adapter 190 bracket of the rotor assembly engages with the external engagement features 195 of the hub adapter 190. The annular rotor assembly 102 can further include a visual indicator, arranged the first rotor element 134, configured to constrain an orientation of the annular rotor assembly 102 relative to the rear disk brake of the bicycle and to guide installation of the annular rotor assembly 102 to the hub adapter 190. Accordingly, the user can close the rotor assembly (e.g., via the hinge and latch) to fix the annular rotor assembly 102 to the hub adapter 190 according to the visual indicator.

### 10. Hub Adapter Variation: Front-Wheel Integration

Generally, the bicycle propulsion system 100 is described herein as configured to: transiently locate on a left side or “off-side” of the bicycle opposite the chain and cogset; and interface with a rear disk brake located on the left side of the bicycle, such as via the hub adapter 190. The hub adapter 190 is configured to intransiently install on a rear axle of a bicycle (e.g., a rear wheel hub of the bicycle) and apply torque to the rear axle through a rear disk brake of the bicycle.

However, the bicycle propulsion system 100 is additionally or alternatively configured to: transiently locate on a left side or “off-side” of the bicycle opposite the chain and cogset; and interface with a front wheel hub and/or front disk brake located on the left side of the bicycle, such as via the hub adapter 190. The hub adapter 190 is configured to intransiently install on a front axle of a bicycle (e.g., a front wheel hub of the bicycle) and apply torque to the front axle through a front disk brake of the bicycle.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A bicycle propulsion system comprising:
a hub adapter:
defining a set of external engagement features; and
configured to intransiently install on a rear axle of a bicycle and apply torque to the rear axle through a rear disk brake of the bicycle;
an annular rotor assembly:
operable in an open configuration and a closed configuration; and
comprising:
a first rotor element;
a second rotor element cooperating with the first rotor element to form a circular outer drive surface around the rear disk brake in the closed configuration;
a first hub adapter bracket:
extending inwardly from the first rotor element; and
defining a first set of retention features configured to engage and retain the set of external engagement features of the hub adapter in the closed configuration; and
a second hub adapter bracket:
extending inwardly from the second rotor element; and
defining a second set of retention features configured to engage and retain the set of external engagement features of the hub adapter in the closed configuration; and
a chassis assembly:
configured to transiently couple to a frame element of the bicycle;
comprising a retention subassembly configured to locate the annular rotor assembly, in the closed configuration, relative to the chassis assembly;
comprising a motor; and
comprising a drive subassembly configured to transfer torque output by the motor into the circular outer drive surface, formed by the first rotor element and the second rotor element in the closed configuration, to rotate the rear axle via the first hub adapter bracket and the second hub adapter bracket.

2. The bicycle propulsion system of claim 1:
wherein, in the closed configuration, the first rotor element and the second rotor element form the outer drive surface defining a continuous timing belt pulley;
wherein the chassis assembly defines a semicircular relief configured to receive less than half of an arc length of the circular outer drive surface defined by the first rotor element and the second rotor element in the closed configuration; and
wherein the drive subassembly comprises:
a set of drive belt rollers adjacent the semicircular relief;
a drive pulley mounted to the motor; and
a timing belt configured to:
mesh with the drive pulley;
run on the set of drive belt rollers;
mesh with the outer drive surface; and
transfer torque output by the motor into the circular outer drive surface.

3. The bicycle propulsion system of claim 2:
wherein the second rotor element cooperates with the first rotor element to form a first running surface on a first side of the circular outer drive surface and a second running surface on a second side of the circular outer drive surface in the closed configuration; and
wherein the retention subassembly comprises a set of outer retaining rollers:
adjacent the semicircular relief; and
configured to ride on the first running surface and the second running surface of the annular rotor assembly to laterally and longitudinally constrain the annular rotor assembly, in the closed configuration, relative to the chassis assembly.

4. The bicycle propulsion system of claim 1:
wherein the first rotor element:
defines a first end;
defines a second end opposite the first end; and
comprises a latching pin proximal the second end; and
wherein the second rotor element:
defines a third end pivotably coupled to the first end of the first rotor element;
defines a fourth end opposite the third end; and
comprises a latch:
proximal the fourth end; and
configured to engage the latching pin to retain the first rotor element and the second rotor element in the closed configuration.

5. The bicycle propulsion system of claim 4, wherein the first rotor element pivots on the second rotor element to transition the annular rotor assembly from the closed configuration to the open configuration, the first hub adapter bracket and the second hub adapter bracket decoupled from the hub adapter in the open configuration.

6. The bicycle propulsion system of claim 1:
wherein the first rotor element and the first hub adapter bracket are physically coextensive; and
wherein the second rotor element and the second hub adapter bracket are physically coextensive.

7. The bicycle propulsion system of claim 1:
wherein the first rotor element spans a first arc segment of a first arcuate length; and
wherein the second rotor element:
spans a second arc segment of a second arcuate length; and
cooperates with the first rotor element to form a contiguous annulus, concentric with the rear disk brake, in the closed configuration.

8. The bicycle propulsion system of claim 1:
wherein the second rotor element cooperates with the first rotor element to form the circular outer drive surface comprising a continuous toothed gear around and concentric with the rear disk brake in the closed configuration; and
wherein the drive subassembly comprises a toothed gear:
arranged on an output shaft of the motor; and
configured to mesh with the continuous toothed gear formed by the first rotor element and the second rotor element in the closed configuration.

9. The bicycle propulsion system of claim 1, wherein the drive subassembly comprises:
a linked arm comprising:
a proximal link defining:
a first end coupled to the chassis assembly; and
a second end coupled to a joint;
a distal link defining:
a third end coupled to the joint; and
a fourth end coupled to the motor; and
the joint:
interposed between the proximal link and the distal link;
configured to pivot about a pivot axis orthogonal to the proximal link and the distal link; and
configured to constrain movement of the articulable arm to the pivot axis during operation of the bicycle.

10. The bicycle propulsion system of claim 9:
wherein the proximal link comprises:
a first drive pulley proximal the first end;
a second drive pulley proximal the second end; and
a first timing belt configured to:
run between the first drive pulley and the second drive pulley; and
mesh with the circular outer drive surface; and
wherein the distal link comprises:
a third drive pulley proximal the third end;
a fourth drive pulley proximal the fourth end and coupled to an output shaft of the motor; and
a second timing belt configured to:
mesh with the third drive pulley and the fourth drive pulley; and
transfer torque output by the motor through the first timing belt and into the circular outer drive surface.

11. The bicycle propulsion system of claim 1:
wherein the first hub adapter bracket comprises:
a third set of retention features:
configured to insert between and to engage a first subset of external engagement features of the hub adapter in the closed configuration; and
interdigitated between the first set of retention features;
a first set of outboard retaining teeth arranged on left sides of the first set of retention features; and
a second set of outboard retaining teeth:
arranged on right sides of the second set of retention features; and
configured to laterally constrain the first hub adapter bracket on the hub adapter; and
wherein the second hub adapter bracket comprises:
a fourth set of retention features:
configured to insert between and to engage a second subset of external engagement features of the hub adapter, distinct from the first subset of engagement features, in the closed configuration; and
interdigitated between the second set of retention features;
a third set of outboard retaining teeth arranged on left sides of the second set of retention features; and
a fourth set of outboard retaining teeth:
arranged on right sides of the fourth set of retention features; and
configured to laterally constrain the second hub adapter bracket on the hub adapter.

12. The bicycle propulsion system of claim 1:
wherein the rear disk brake of the bicycle defines a set of cutouts angularly offset by a pitch angle; and
wherein the hub adapter defines:
a front face defining a first set of threaded bores:
distributed along the front face;
angularly offset by the pitch angle; and
configured to receive a set of fasteners to transiently couple the front face of the hub adapter to the rear disk brake of the bicycle; and
a rear face:
opposite the front face; and
defining a through-bore configured to pass the rear axle of the rear wheel of the bicycle.

13. The bicycle propulsion system of claim 12:
wherein in a first configuration:
the rear axle runs through the through-bore of the rear face of the hub adapter;
the front face of the hub adapter is removably fastened to the rear disk brake of the bicycle;
the annular rotor assembly is concentric with the rear disk brake of the bicycle and engaged with external engagement features of the hub adapter; and
the chassis assembly is coupled to the frame element of the bicycle and proximal the annular rotor assembly; and
wherein in a second configuration:
the rear axle runs through the through-bore of the rear face of the hub adapter;
the front face of the hub adapter is removably fastened to the rear disk brake of the bicycle;
the annular rotor assembly is mounted to the rear disk brake of the bicycle and engaged with external engagement features of the hub adapter; and
the chassis assembly is coupled to the frame element of the bicycle and proximal the annular rotor assembly.

14. The bicycle propulsion system of claim 1:
wherein the first rotor element defines a first visual indicator configured to constrain a first orientation of the annular rotor assembly relative to the rear disk brake of the bicycle; and
wherein the hub adapter defines a second visual indicator configured to constrain a second orientation of the hub adapter relative to the rear axle of the rear wheel of the bicycle.

15. The bicycle propulsion system of claim 1:
wherein the hub adapter defines:
a first diameter and a first thickness; and
a through-bore:
defining a second diameter less than the first diameter; and
configured to pass the rear axle running from a rear wheel hub on the right side of the bicycle to a chain stay on the left side of the bicycle; and
wherein the annular rotor assembly is laterally offset from the rear disk brake, by the first thickness of the hub adapter, to prevent collision between the annular rotor assembly and a brake caliper of the rear disk brake.

16. A bicycle propulsion system comprising:
a hub adapter configured to intransiently install on a rear axle of a bicycle and apply torque to the rear axle through a rear disk brake of the bicycle;
an annular rotor assembly:
operable in an open configuration and a closed configuration; and
comprising:
a first rotor element;
a second rotor element cooperating with the first rotor element to form a circular outer drive surface around the rear axle in the closed configuration, the circular outer drive surface defining a timing belt;
a first hub adapter bracket inset from the first rotor element, coupled to the first rotor element, and configured to engage the hub adapter in the closed configuration; and
a second hub adapter bracket inset from the second rotor element, coupled to the second rotor element, and configured to engage the hub adapter in the closed configuration;
a rotor retainer configured to transiently couple to a frame element of the bicycle and locate the annular rotor assembly, in the closed configuration, relative to the frame element of the bicycle; and
a power transmission assembly:
comprising a motor proximal the frame element of the bicycle;
comprising a linked arm mounted to the motor and configured to mesh with the timing belt; and
configured to transfer torque output by the motor to the timing belt to rotate the rear axle via the first hub adapter bracket and the second hub adapter bracket in the closed configuration.

17. The bicycle propulsion system of claim 16, wherein the linked arm comprises:
a first drive shaft;
a second drive shaft coupled to the motor; and
a set of miter gears:
pivotably coupled to the first drive shaft and the second drive shaft;
defining a shaft angle within a target shaft angle range to angularly offset the first drive shaft from the second drive shaft; and
configured to transfer torque output by the motor from the second drive shaft, to the first drive shaft, and into the first timing belt.

18. The bicycle propulsion system of claim 16:
wherein the linked arm comprises:
a first link comprising:
a set of drive pulleys; and
a second timing belt configured to run between the set of drive pulleys and mesh with the first timing belt;
a second link:
mounted to the motor;
comprising a second set of drive pulleys; and
comprising a third timing belt configured to run between the second set of drive pulleys; and
a joint interposed between the first link and the second link and configured to pivot the linked arm about a pivot axis orthogonal to the first link and the second link; and
wherein the power transmission assembly is configured to transfer torque output by the motor, through the third timing belt, through the second timing belt, and into the first timing belt to rotate the rear axle via the first hub adapter bracket and the second hub adapter bracket in the closed configuration.

19. The bicycle propulsion system of claim 16:
further comprising a user interface coupled to a handlebar of the bicycle; and
wherein the power transmission assembly further comprises a controller:
arranged on the linked arm; and
configured to:
actuate the motor to rotate the annular rotor assembly in response to a first user input via the user interface; and
halt the motor to cease rotation of the annular rotor assembly in response to a second user input via the user interface.

20. A bicycle propulsion system comprising:
a hub adapter configured to intransiently install on a front axle of a bicycle and apply torque to the front axle;
a first rotor element;
a second rotor element cooperating with the first rotor element to:
form a circular outer drive surface around a front disk brake of the bicycle in a closed configuration; and
decouple from the front disk brake in an open configuration;
a first hub adapter bracket inset from the first rotor element, coupled to the first rotor element, and configured to engage the hub adapter in the closed configuration;
a second hub adapter bracket inset from the second rotor element, coupled to the second rotor element, and configured to engage the hub adapter in the closed configuration;
a rotor retainer arranged on the chassis and configured to locate the first rotor element and the second rotor element, in the closed configuration, relative to the chassis;
a motor mounted to the chassis; and
a drive assembly:
arranged on the chassis; and
configured to transfer torque output by the motor into the circular outer drive surface, formed by the first rotor element and the second rotor element in the closed configuration, to rotate the front axle via the first hub adapter bracket and the second hub adapter bracket.
